(19) United States
(12) Patent Application Publication
(10) Pub. No.: US 2025/0168846 A1
(43) Pub. Date: May 22, 2025

(54) UPLINK MULTIPLEXING FOR MULTIPLE TRANSMISSION RECEPTION POINT OPERATIONS

(71) Applicant: QUALCOMM Incorporated, San Diego, CA (US)

(72) Inventors: Fang YUAN, Beijing (CN); Yan ZHOU, San Diego, CA (US); Mostafa KHOSHNEVISAN, San Diego, CA (US); Jing SUN, San Diego, CA (US); Tao LUO, San Diego, CA (US); Peter GAAL, San Diego, CA (US)

(21) Appl. No.: 18/841,214

(22) PCT Filed: Apr. 29, 2022
(86) PCT No.: PCT/CN2022/090537

§ 371 Date: Aug. 23, 2024

(51) Int. Cl. H04W 72/1268; H04L 5/00

(52) U.S. Cl. CPC H04W 72/1268; H04L 5/0053

(57) ABSTRACT

Methods, systems, and devices for wireless communications are described. A user equipment (UE) may receive scheduling information for an uplink shared channel transmission, the scheduling information indicating multiple transmission configuration indicator (TCI) states. The UE may transmit a first portion of the uplink shared channel multiplexed with uplink control information (UCI) using a first set of resources and in accordance with a first TCI state. Similarly, the UE may transmit a second portion of the uplink shared channel multiplexed with UCI using a second set of resources and in accordance with a second TCI state. The first set of resources and the second set of resources may overlap in time, but not in frequency. A network entity may receive and decode the first portion and the second portion of the uplink shared channel.

### CROSS REFERENCE

The present application is a 371 national stage filing of International PCT Application No. PCT/CN2022/090537 by YUAN et al. entitled “UPLINK MULTIPLEXING FOR MULTIPLE TRANSMISSION RECEPTION POINT OPERATIONS,” filed Apr. 29, 2022, which is assigned to the assignee hereof, and which is expressly incorporated by reference in its entirety herein.

### FIELD OF TECHNOLOGY

The following relates to wireless communications, including uplink multiplexing for multiple transmission reception point (multi-TRP) operations.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

### SUMMARY

The described techniques relate to improved methods, systems, devices, and apparatuses that support uplink multiplexing for multiple transmission reception point (multi-TRP) operations. For example, the described techniques provide for a user equipment (UE) to transmit portions of an uplink shared channel (e.g., a physical uplink shared channel (PUSCH)) multiplexed with uplink control information (UCI) using multiple transmission configuration indicator (TCI) states. For example, the UE may receive scheduling information from a network entity indicating multiple TCI states for the uplink shared channel. The UE may perform a frequency division multiplexing (FDM) operation to transmit different portions of the uplink shared channel to different TRPs in a multi-TRP system concurrently and using different beams (e.g., the respective TCI states). The UE may multiplex the different portions of the uplink shared channel with UCI, such as a same UCI for the different portions or a different UCI (e.g., different UCI payload or coded bits) per portion of the uplink shared channel.

A method for wireless communications at a UE is described. The method may include receiving a control message indicating scheduling information for an uplink shared channel for the UE, the scheduling information indicating multiple TCI states for the uplink shared channel, transmitting, via a first set of resources, a first portion of the uplink shared channel multiplexed with first UCI in accordance with a first TCI state of the multiple TCI states, and transmitting, via a second set of resources that at least partially overlaps the first set of resources in time, a second portion of the uplink shared channel multiplexed with second UCI in accordance with a second TCI state of the multiple TCI states.

An apparatus for wireless communications at a UE is described. The apparatus may include a processor, memory coupled with the processor, and instructions stored in the memory. The instructions may be executable by the processor to cause the apparatus to receive a control message indicating scheduling information for an uplink shared channel for the UE, the scheduling information indicating multiple TCI states for the uplink shared channel, transmit, via a first set of resources, a first portion of the uplink shared channel multiplexed with first UCI in accordance with a first TCI state of the multiple TCI states, and transmit, via a second set of resources that at least partially overlaps the first set of resources in time, a second portion of the uplink shared channel multiplexed with second UCI in accordance with a second TCI state of the multiple TCI states.

Another apparatus for wireless communications at a UE is described. The apparatus may include means for receiving a control message indicating scheduling information for an uplink shared channel for the UE, the scheduling information indicating multiple TCI states for the uplink shared channel, means for transmitting, via a first set of resources, a first portion of the uplink shared channel multiplexed with first UCI in accordance with a first TCI state of the multiple TCI states, and means for transmitting, via a second set of resources that at least partially overlaps the first set of resources in time, a second portion of the uplink shared channel multiplexed with second UCI in accordance with a second TCI state of the multiple TCI states.

A non-transitory computer-readable medium storing code for wireless communications at a UE is described. The code may include instructions executable by a processor to receive a control message indicating scheduling information for an uplink shared channel for the UE, the scheduling information indicating multiple TCI states for the uplink shared channel, transmit, via a first set of resources, a first portion of the uplink shared channel multiplexed with first UCI in accordance with a first TCI state of the multiple TCI states, and transmit, via a second set of resources that at least partially overlaps the first set of resources in time, a second portion of the uplink shared channel multiplexed with second UCI in accordance with a second TCI state of the multiple TCI states.

Some examples of the method, apparatuses, and non-transitory computer-readable medium described herein may further include operations, features, means, or instructions for generating the second UCI based on the first UCI, where the second UCI may be a copy of the first UCI.

Some examples of the method, apparatuses, and non-transitory computer-readable medium described herein may further include operations, features, means, or instructions for encoding the first UCI according to a set of encoding parameters associated with the first TCI state, where the second UCI may be generated based on the encoded first UCI.

Some examples of the method, apparatuses, and non-transitory computer-readable medium described herein may further include operations, features, means, or instructions for performing rate matching for the first UCI according to a rate matching scheme associated with the first TCI state, where the second UCI may be generated based on the rate matched first UCI.

Some examples of the method, apparatuses, and non-transitory computer-readable medium described herein may further include operations, features, means, or instructions for encoding the first UCI according to a first encoding scheme, performing, after encoding the first UCI, rate matching for the first UCI according to a first rate matching scheme, and multiplexing the first UCI with the first portion of the uplink shared channel after performing rate matching for the first UCI.

Some examples of the method, apparatuses, and non-transitory computer-readable medium described herein may further include operations, features, means, or instructions for encoding the second UCI according to a second encoding scheme, performing, after encoding the second UCI, rate matching for the second UCI according to a second rate matching scheme, and multiplexing the second UCI with the second portion of the uplink shared channel after performing rate matching for the second UCI.

In some examples of the method, apparatuses, and non-transitory computer-readable medium described herein, the first encoding scheme may be different from the second encoding scheme.

In some examples of the method, apparatuses, and non-transitory computer-readable medium described herein, the first rate matching scheme may be different from the second rate matching scheme.

Some examples of the method, apparatuses, and non-transitory computer-readable medium described herein may further include operations, features, means, or instructions for performing an encoding and rate matching procedure for a first set of UCI based on a first encoding and rate matching scheme associated with the first TCI state to obtain the first UCI.

In some examples of the method, apparatuses, and non-transitory computer-readable medium described herein, performing the encoding and rate matching procedure for the first set of UCI may include operations, features, means, or instructions for determining a number of coded symbols per layer for the first set of UCI, omitting one or more bits of the first set of UCI, and determining one or more sequence lengths for different subsets of information of the first set of UCI after omitting the one or more bits.

Some examples of the method, apparatuses, and non-transitory computer-readable medium described herein may further include operations, features, means, or instructions for performing an encoding and rate matching procedure for a second set of UCI based on an encoding and rate matching scheme to obtain the second UCI.

In some examples of the method, apparatuses, and non-transitory computer-readable medium described herein, performing the encoding and rate matching procedure for the second set of UCI may include operations, features, means, or instructions for determining a number of coded symbols per layer for the second set of UCI, omitting one or more bits of the second set of UCI, and determining one or more sequence lengths for different subsets of information of the second set of UCI after omitting the one or more bits.

Some examples of the method, apparatuses, and non-transitory computer-readable medium described herein may further include operations, features, means, or instructions for generating the first portion of the uplink shared channel based on a first redundancy version (RV) and generating the second portion of the uplink shared channel based on a second RV different from the first RV.

Some examples of the method, apparatuses, and non-transitory computer-readable medium described herein may further include operations, features, means, or instructions for generating the first portion and the second portion of the uplink shared channel based on a same RV.

Some examples of the method, apparatuses, and non-transitory computer-readable medium described herein may further include operations, features, means, or instructions for receiving a second control message configuring the UE to operate in a FDM mode for uplink shared channel transmissions.

Some examples of the method, apparatuses, and non-transitory computer-readable medium described herein may further include operations, features, means, or instructions for splitting the uplink shared channel into the first portion based on a ceiling function and a number of resource blocks associated with the uplink shared channel and splitting the uplink shared channel into the second portion based on a floor function and the number of resource blocks associated with the uplink shared channel.

In some examples of the method, apparatuses, and non-transitory computer-readable medium described herein, the first set of resources and the second set of resources may be non-overlapping in frequency.

A method for wireless communications at a network entity is described. The method may include transmitting a control message indicating scheduling information for an uplink shared channel for a UE, the scheduling information indicating multiple TCI states for the uplink shared channel, receiving, via a first set of resources, a first portion of the uplink shared channel multiplexed with first UCI in accordance with a first TCI state of the multiple TCI states, and receiving, via a second set of resources that at least partially overlaps the first set of resources in time, a second portion of the uplink shared channel multiplexed with second UCI in accordance with a second TCI state of the multiple TCI states.

An apparatus for wireless communications at a network entity is described. The apparatus may include a processor, memory coupled with the processor, and instructions stored in the memory. The instructions may be executable by the processor to cause the apparatus to transmit a control message indicating scheduling information for an uplink shared channel for a UE, the scheduling information indicating multiple TCI states for the uplink shared channel, receive, via a first set of resources, a first portion of the uplink shared channel multiplexed with first UCI in accordance with a first TCI state of the multiple TCI states, and receive, via a second set of resources that at least partially overlaps the first set of resources in time, a second portion of the uplink shared channel multiplexed with second UCI in accordance with a second TCI state of the multiple TCI states.

Another apparatus for wireless communications at a network entity is described. The apparatus may include means for transmitting a control message indicating scheduling information for an uplink shared channel for a UE, the scheduling information indicating multiple TCI states for the uplink shared channel, means for receiving, via a first set of resources, a first portion of the uplink shared channel multiplexed with first UCI in accordance with a first TCI state of the multiple TCI states, and means for receiving, via a second set of resources that at least partially overlaps the first set of resources in time, a second portion of the uplink shared channel multiplexed with second UCI in accordance with a second TCI state of the multiple TCI states.

A non-transitory computer-readable medium storing code for wireless communications at a network entity is described. The code may include instructions executable by a processor to transmit a control message indicating scheduling information for an uplink shared channel for a UE, the scheduling information indicating multiple TCI states for the uplink shared channel, receive, via a first set of resources, a first portion of the uplink shared channel multiplexed with first UCI in accordance with a first TCI state of the multiple TCI states, and receive, via a second set of resources that at least partially overlaps the first set of resources in time, a second portion of the uplink shared channel multiplexed with second UCI in accordance with a second TCI state of the multiple TCI states.

Some examples of the method, apparatuses, and non-transitory computer-readable medium described herein may further include operations, features, means, or instructions for transmitting a second control message configuring the UE to operate in a FDM mode for uplink shared channel transmissions.

Some examples of the method, apparatuses, and non-transitory computer-readable medium described herein may further include operations, features, means, or instructions for performing a decoding and rate matching procedure for the first UCI based on a first encoding and rate matching scheme associated with the first TCI state and performing the decoding and rate matching procedure for the second UCI based on the first encoding and rate matching scheme associated with the first TCI state.

In some examples of the method, apparatuses, and non-transitory computer-readable medium described herein, the first UCI and the second UCI may be the same.

Some examples of the method, apparatuses, and non-transitory computer-readable medium described herein may further include operations, features, means, or instructions for performing a first decoding and rate matching procedure for the first UCI based on a first encoding and rate matching scheme associated with the first TCI state.

Some examples of the method, apparatuses, and non-transitory computer-readable medium described herein may further include operations, features, means, or instructions for performing a second decoding and rate matching procedure for the second UCI based on a second encoding and rate matching scheme associated with the second TCI state.

In some examples of the method, apparatuses, and non-transitory computer-readable medium described herein, the first UCI and the second UCI may be different.

In some examples of the method, apparatuses, and non-transitory computer-readable medium described herein, the first set of resources and the second set of resources may be non-overlapping in frequency.

### BRIEF DESCRIPTION OF THE DRAWINGS

FIGS. 1 and 2 illustrates an example of a wireless communications system that supports uplink multiplexing for multiple transmission reception point (multi-TRP) operations in accordance with one or more aspects of the present disclosure.

FIGS. 3A and 3B illustrate examples of resource diagrams that support uplink multiplexing for multi-TRP operations in accordance with one or more aspects of the present disclosure.

FIG. 4 illustrates an example of a process flow that supports uplink multiplexing for multi-TRP operations in accordance with one or more aspects of the present disclosure.

FIGS. 5 and 6 show block diagrams of devices that support uplink multiplexing for multi-TRP operations in accordance with one or more aspects of the present disclosure.

FIG. 7 shows a block diagram of a communications manager that supports uplink multiplexing for multi-TRP operations in accordance with one or more aspects of the present disclosure.

FIG. 8 shows a diagram of a system including a device that supports uplink multiplexing for multi-TRP operations in accordance with one or more aspects of the present disclosure.

FIGS. 9 and 10 show block diagrams of devices that support uplink multiplexing for multi-TRP operations in accordance with one or more aspects of the present disclosure.

FIG. 11 shows a block diagram of a communications manager that supports uplink multiplexing for multi-TRP operations in accordance with one or more aspects of the present disclosure.

FIG. 12 shows a diagram of a system including a device that supports uplink multiplexing for multi-TRP operations in accordance with one or more aspects of the present disclosure.

FIGS. 13 through 16 show flowcharts illustrating methods that support uplink multiplexing for multi-TRP operations in accordance with one or more aspects of the present disclosure.

### DETAILED DESCRIPTION

In some wireless communication systems, a user equipment (UE) may communicate with a network entity via one or more transmission reception points (TRPs), such as in a multi-TRP system. A TRP may relay information to and from one or more UEs and one or more network entities, such as uplink and downlink signaling. For example, a network entity may configure communications with a UE in the multi-TRP system according to an frequency division multiplexing (FDM) scheme, such that the UE may transmit or receive data from the TRPs using different beams (e.g., time-frequency resources in a spatial direction) in different frequency resources over a given time interval. Each beam may have a corresponding transmission configuration indicator (TCI) state, which may define a quasi-colocation (QCL) relationship between antenna ports of a source wireless device and a target, or destination, wireless device (e.g., the UE and a TRP). In some cases, the UE may multiplex uplink control information (UCI) with an uplink shared channel for transmission to the network entity. However, some multiplexing techniques may not support multiplexing of UCI using different beams (e.g., in the multi-TRP system for FDM) and therefore a UE may be unable to perform such multiplexing.

As described herein, a UE may multiplex the UCI over a split uplink shared channel by generating UCI bits for each portion of the uplink shared channel. For example, the UE may multiplex the UCI with a portion of the uplink shared channel and may multiplex a copy of the UCI for an additional portion of the uplink shared channel. In some other examples, the UE may perform different encoding and rate matching to multiplex different UCI in the respective different portions of the uplink shared channel. A network entity may configure the TCI states (e.g., beams) for each portion of the uplink shared channel via control signaling, such as radio resource control (RRC) signaling. The UE may transmit each portion of the uplink shared channel using a beam respective to a TCI state for the portion of the uplink shared channel. The UE may transmit the portions of the uplink shared channel according to an FDM scheme in which time resources of the transmissions may overlap (at least partially), while the frequency resources are independent (e.g., non-overlapping) for each portion of the uplink shared channel.

Aspects of the disclosure are initially described in the context of wireless communications systems. Aspects of the disclosure are further described in the context of resource diagrams and process flows. Aspects of the disclosure are further illustrated by and described with reference to apparatus diagrams, system diagrams, and flowcharts that relate to uplink multiplexing for multi-TRP operations.

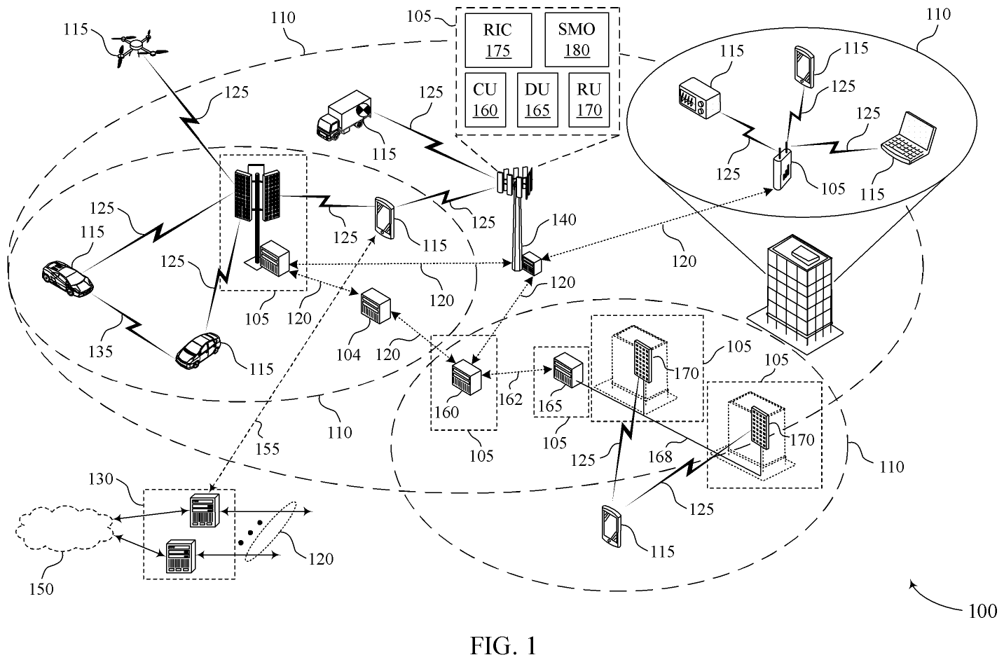

FIG. 1 illustrates an example of a wireless communications system 100 that supports uplink multiplexing for multi-TRP operations in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending upon which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., RRC, service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support uplink multiplexing for multi-TRP operations as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal FDM (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Ts=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (STTIs)).

Physical channels may be multiplexed on a carrier according to various techniques. A physical control channel and a physical data channel may be multiplexed on a downlink carrier, for example, using one or more of time division multiplexing (TDM) techniques, FDM (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

A network entity 105 may provide communication coverage via one or more cells, for example a macro cell, a small cell, a hot spot, or other types of cells, or any combination thereof. The term “cell” may refer to a logical communication entity used for communication with a network entity 105 (e.g., over a carrier) and may be associated with an identifier for distinguishing neighboring cells (e.g., a physical cell identifier (PCID), a virtual cell identifier (VCID), or others). In some examples, a cell may also refer to a coverage area 110 or a portion of a coverage area 110 (e.g., a sector) over which the logical communication entity operates. Such cells may range from smaller areas (e.g., a structure, a subset of structure) to larger areas depending on various factors such as the capabilities of the network entity 105. For example, a cell may be or include a building, a subset of a building, or exterior spaces between or overlapping with coverage areas 110, among other examples.

A macro cell generally covers a relatively large geographic area (e.g., several kilometers in radius) and may allow unrestricted access by the UEs 115 with service subscriptions with the network provider supporting the macro cell. A small cell may be associated with a lower-powered network entity 105 (e.g., a lower-powered base station 140), as compared with a macro cell, and a small cell may operate in the same or different (e.g., licensed, unlicensed) frequency bands as macro cells. Small cells may provide unrestricted access to the UEs 115 with service subscriptions with the network provider or may provide restricted access to the UEs 115 having an association with the small cell (e.g., the UEs 115 in a closed subscriber group (CSG), the UEs 115 associated with users in a home or office). A network entity 105 may support one or multiple cells and may also support communications over the one or more cells using one or multiple component carriers.

In some examples, a carrier may support multiple cells, and different cells may be configured according to different protocol types (e.g., MTC, narrowband IoT (NB-IoT), enhanced mobile broadband (eMBB)) that may provide access for different types of devices.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may support synchronous or asynchronous operation. For synchronous operation, network entities 105 (e.g., base stations 140) may have similar frame timings, and transmissions from different network entities 105 may be approximately aligned in time. For asynchronous operation, network entities 105 may have different frame timings, and transmissions from different network entities 105 may, in some examples, not be aligned in time. The techniques described herein may be used for either synchronous or asynchronous operations.

Some UEs 115, such as MTC or IoT devices, may be low cost or low complexity devices and may provide for automated communication between machines (e.g., via Machine-to-Machine (M2M) communication). M2M communication or MTC may refer to data communication technologies that allow devices to communicate with one another or a network entity 105 (e.g., a base station 140) without human intervention. In some examples, M2M communication or MTC may include communications from devices that integrate sensors or meters to measure or capture information and relay such information to a central server or application program that makes use of the information or presents the information to humans interacting with the application program. Some UEs 115 may be designed to collect information or enable automated behavior of machines or other devices. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging.

Some UEs 115 may be configured to employ operating modes that reduce power consumption, such as half-duplex communications (e.g., a mode that supports one-way communication via transmission or reception, but not transmission and reception concurrently). In some examples, half-duplex communications may be performed at a reduced peak rate. Other power conservation techniques for the UEs 115 include entering a power saving deep sleep mode when not engaging in active communications, operating over a limited bandwidth (e.g., according to narrowband communications), or a combination of these techniques. For example, some UEs 115 may be configured for operation using a narrowband protocol type that is associated with a defined portion or range (e.g., set of subcarriers or resource blocks (RBs)) within a carrier, within a guard-band of a carrier, or outside of a carrier.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may also operate in a super high frequency (SHF) region using frequency bands from 3 GHz to 30 GHz, also known as the centimeter band, or in an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, this may facilitate use of antenna arrays within a device. The propagation of EHF transmissions, however, may be subject to even greater atmospheric attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

In some examples, one or more UCI multiplexing rules may be defined at or supported by a UE 115, such that a UE 115 may piggyback (e.g., multiplex) UCI on an uplink shared channel, such as a physical uplink shared channel (PUSCH). In single TRP operations, UCI multiplexing rules may define multiplexing UCI bits with PUSCH bits. In multi-TRP operations (e.g., with multiple TCI states), the UE 115 may perform UCI multiplexing in time division multiplexing (TDM) modes. In the TDM mode, the UE 115 may multiplex UCI using a single TCI state and send the multiplexed UCI over time resources for one PUSCH that may not overlap with time resources of a different PUSCH associated with a different TCI state. However, rules may not be defined, and thus a UE 115 may not support, UCI multiplexing for a multi-TRP operation mode for an FDM mode, where multiple TCI states may be transmitted over the same time duration (or at least partially overlapping in time).

In some examples, a network entity 105 may define one or more rules for a UE 115 to multiplex UCI on a PUSCH for multi-TRP scenarios (e.g., when a UE 115 is scheduled with a single PUSCH for multiple TCI states). A network entity 105 may schedule a single PUSCH with multiple TCI states, and the UE 115 may split the single PUSCH into multiple portions, which the UE 115 may transmit at a same time using different TCI states. In some cases, the UE 115 may encode and rate match UCI according to one TCI state per portion of a PUSCH, and then the UE 115 may copy and multiplex the encoded and rate-matched UCI bits with one or more different portions of the PUSCH. The portions of the PUSCH may have the same or different redundancy versions (RVs). The UE 115 may transmit the multiplexed UCIs with the PUSCH in an FDM manner, such that the UE 115 may transmit the TCI states at a same time. In some other cases, the UE 115 may encode and rate-match the UCI separately for each TCI state. For example, the UE 115 may encode and rate match first UCI according to a first TCI state and multiplex the encoded and rate matched first UCI with a first portion of the PUSCH for transmission. Additionally, or alternatively, the UE 115 may encode and rate match second UCI (e.g., with different rate matching and encoding schemes than the first UCI) according to a second TCI state, and then multiplex the encoded and rate matched second UCI with a second portion of the PUSCH for transmission. The first UCI and the second UCI may have the same UCI payload.

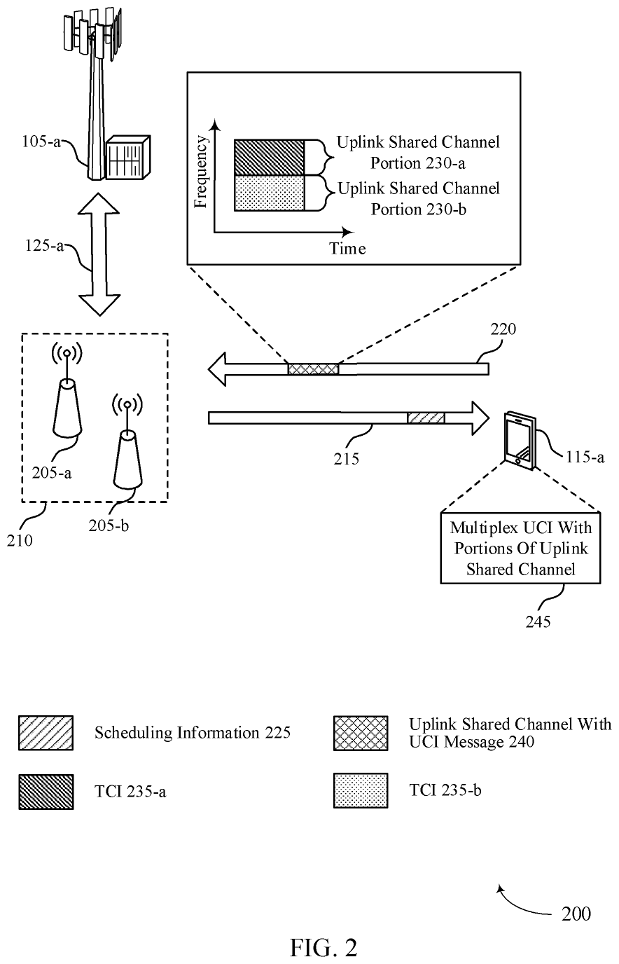

FIG. 2 illustrates an example of a wireless communications system 200 that supports uplink multiplexing for multi-TRP operations in accordance with one or more aspects of the present disclosure. The wireless communications system 200 may implement or be implemented to realize aspects of the wireless communications system 100. For example, the wireless communications system 200 illustrates communication between one or more UEs and network entities, such as a UE 115-a, a TRP 205-a, a TRP 205-b, and a network entity 105-a, which may be examples of corresponding devices described herein, including with reference to FIG. 1. The wireless communications system 200 may support signaling including a multiplexed transmission from a UE 115-a to the network entity 105-a via the TRP 205-a, the TRP 205-b, or both in an FDM mode.

In some cases, the UE 115-a, the TRP 205-a, the TRP 205-b, or any combination thereof may be in communication with the network entity 105-a. For example, the network entity 105-a may transmit control information, data, or both to the UE 115-a via a group of one or more TRPs (e.g., the TRP 205-a, the TRP 205-b, or both in the multi-TRP system 210) using a communication link 125-a between the TRP 205-a, the TRP 205-b, or both and the network entity 105-a and a downlink communication link 215 between the TRP 205-a, the TRP 205-b, or both and the UE 115-a. Similarly, the UE 115-a may transmit control information, data or both to the network entity 105-a via the TRP 205-a, the TRP 205-b, or both using the communication link 125-a and an uplink communication link 220 between the TRP 205-a, the TRP 205-b, or both. The communication link 215-a may be an example of a communication link 125 as described with reference to FIG. 1.

In some examples, the multi-TRP system 210 may include any number of TRPs, such as a TRP 205-a and a TRP 205-b. Each TRP in the multi-TRP system 210 may relay information between the network entity 105-a and one or more UEs (e.g., including a UE 115-a). Additionally, or alternatively, one or more TRPs in the TRP system 210 may have the functionality of a network entity, such as the network entity 105-a, and may communicate with the UEs independent of the network entity 105-a. In some cases, the multi-TRP system 210 may include vehicles in a V2X system, one or more customer premise equipment (CPE), a fixed wireless access (FWA) system, one or more industrial devices in an IoT system, or any combination thereof.

In some cases, the UE 115-a may use multiple TCI states to communicate with the TRPs in the multi-TRP system 210. Each TCI state may identify a beam with a respective communication direction and resources. For example, the network entity 105-a may indicate for the UE 115-a to operate in an FDM mode. The UE 115-a may perform multiple transmissions concurrently using different beams and frequency resources. The TCI states may include one or more downlink TCI states for communication from the network entity 105-a to the UE 115-a. Additionally, or alternatively, the TCI states may include one or more uplink TCI states for communication from the UE 115-a to the network entity 105-a. In some cases, the UE 115-a may perform simultaneous multi-panel uplink transmissions to increase uplink throughput and reliability of the signaling. The UE 115-a may use one or more frequencies in a frequency range (e.g., a Frequency Range 2 including frequency bands from 24.25 GHz to 52.6 GHz) for the simultaneous transmissions in the FDM mode.

In some examples, the UE 115-a and the network entity 105-a may implement a precoding technique in which a transmitting device may send coded information to a receiving device, such that the receiving device may determine information about a communication channel. Thus, the transmitting device and the receiving device may use a common codebook for communications over the communication channel. For example, the UE 115-a may transmit an uplink precoding indication for an uplink shared channel transmission, where there may not be a different codebook for multi-panel simultaneous transmissions under an FDM scheme. In some cases, a total number of signaling layers may be up to four across all transmission panels at the UE 115-a and a total number of codewords may be up to two across the panels. The UE 115-a and the network entity 105-a may use a single downlink control information (DCI) message or a multiple DCI message for configuring the multi-TRP operations. In some examples, the UE 115-a may transmit an uplink beam indication for an uplink control channel, an uplink shared channel, or both (e.g., a physical uplink control channel (PUCCH) and a PUSCH). For a multiple DCI message based multi-TRP operation, a UE 115-a may transmit two PUSCHs or two PUCCHs across two panels in a same component carrier (CC).

In some examples, the network entity 105-a may define one or more rules, or procedures, for the UE 115-a to support multiplexing UCI with an uplink shared channel for communications in a multi-TRP system 210. The network entity 105-a may transmit scheduling information 225 to the UE 115-a in control signaling, such as a DCI message, RRC signaling, a medium access control-control element (MAC-CE), or the like. In some cases, the network entity 105-a may transmit the scheduling information 225 via one or more of the TRPs in the multi-TRP system 210, such as via a TRP 205-a, a TRP 205-b, or both using the communication link 125-a and the downlink communication link 215. In some other cases, the network entity 105-a may transmit the scheduling information 225 to the UE 115-a directly.

The scheduling information 225 may schedule an uplink shared channel transmission, including one or more portions of the uplink shared channel (e.g., uplink shared channel portion 230-a, uplink shared channel portion 230-b, or both). For example, the scheduling information 225 may indicate one or more time-frequency resources for the UE 115-a to use for the uplink shared channel transmission. Additionally, or alternatively, the scheduling information 225 may include one or more TCI states for the UE 115-a to use for the uplink shared channel transmission. The network entity 105-a may indicate for the UE 115-a to use one TCI state per TRP in the multi-TRP system. That is, the scheduling information 225 may indicate a TCI state 235-a for the UE 115-a to use when transmitting the uplink shared channel portion 230-a to the UE 115-a via a TRP 205-a and a TCI state 235-b for the UE 115-a to use when transmitting the uplink shared channel portion 230-b to the UE 115-a via a TRP 205-b.

In some examples, the scheduling information 225 may define one or more splitting rules for a time-frequency resource allocation for each portion of the uplink shared channel transmission. For example, the UE 115-a may apply a first ceiling, ceil (NPRB/2), with a number of physical resource blocks (PRBs) for a first frequency domain resource allocation (FDRA) split of the uplink shared channel (e.g., to determine the PRBs for the uplink shared channel portion 230-a for the TRP 205-a and TCI state 235-a), where NPRB is a total number of allocated PRBs in a FDRA for the UE 115-a. Similarly, the UE 115-a may apply a remaining floor, floor (NPRB/2), to determine a number of PRBs for the second FDRA split of the uplink shared channel (e.g., to determine the PRBs for the uplink shared channel portion 230-b for the TRP 205-b and TCI state 235-b).

The network entity 105-a may indicate for the UE 115-a to operate in an FDM transmission mode. In some cases, the network entity 105-a may include an explicit indication in the control signaling including the scheduling information 225. In some other cases, the UE 115-a may infer from the scheduling information 225 that the UE 115-a is to operate in an FDM transmission mode. For example, if the scheduling information 225 includes one or more overlapping time resources for the uplink shared channel portion 230-a and the uplink shared channel portion 230-b and different frequency resources for the uplink shared channel portion 230-a and the uplink shared channel portion 230-b, the UE 115-a may perform the uplink shared channel transmissions in the FDM transmission mode.

In some cases, the UE 115-a may be configured to piggyback, or multiplex, UCI on a scheduling uplink shared channel transmission, such that the UE 115-a may transmit an uplink shared channel with UCI message 240. The UE 115-a may receive higher layer signaling indicating for the UE to multiplex the UCI on the uplink shared channel transmission. Additionally, or alternatively, the multiplexing of the uplink shared channel with the UCI may be otherwise defined (e.g., predetermined or predefined at the UE 115-a). In some examples, the scheduling information 225 may split the uplink shared channel for transmission in different frequency resources using one or more FDRA indicators. For example, the FDRA may split the uplink shared channel message into a portion for each TRP in the multi-TRP system 210 (e.g., an uplink shared channel portion 230-a for the TRP 205-a and an uplink shared channel portion 230-b for the TRP 205-b). The UE 115-a may include a same UCI payload in different portions of the split uplink shared channel.

In some cases, at 245, the UE 115-a may multiplex the portions of the uplink shared channel with the UCI. For example, the UE 115-a my perform UCI encoding and rate matching based on a single TRP 205-a or TRP 205-b. That is, the UE 115-a may determine a lower FDRA for the split uplink shared channel (e.g., for a lower frequency range), such as an FDRA for the uplink shared channel portion 230-b. The UE 115-a may encode and rate match the UCI with the uplink shared channel portion 230-b based on the uplink shared channel portion 230-b having a lower FDRA. The UE 115-a may copy and repeat the same UCI coded bits for other portions of the uplink shared channel message to different TRPs, such as the uplink shared channel portion 230-a to the TRP 205-a with a higher FDRA. The UE 115-a may copy and repeat the same UCI coded bits if the uplink shared channel includes multiple RVs in different portions of the uplink shared channel. For example, if the uplink shared channel portion 230-b includes a first RV of the uplink shared channel message and the uplink shared channel portion 230-a includes a subsequent (e.g., second) RV of the uplink shared channel message, the UE 115-a may copy and repeat the UCI across the uplink shared channel portion 230-a and the uplink shared channel portion 230-b. Additionally, or alternatively, if the uplink shared channel portion 230-b includes a RV of the uplink shared channel message and the uplink shared channel portion 230-a includes a same RV of the uplink shared channel message, the UE 115-a may copy and repeat the UCI across the uplink shared channel portion 230-a and the uplink shared channel portion 230-b.

In some other examples, the UE 115-a may perform the encoding and rate matching of the UCI separately for different TRPs in the multi-TRP system 210. The UE 115-a may perform UCI encoding and rate matching based on a lowest or highest FDRA for the portions of the uplink shared channel message. That is, the UE 115-a may determine the uplink shared channel portion 230-b has a lowest FDRA, the uplink shared channel portion 230-a has a highest FDRA, or both. The UE 115-a may multiplex a portion of bits of the UCI with the uplink shared channel portion 230-a and a different portion of bits of the UCI with the uplink shared channel portion 230-b based on determining the lowest FDRA, the highest FDRA, or both. The UE 115-a may perform separate UCI encoding and rate matching if the different portions of the uplink shared channel message include multiple RVs. In some examples, the UE 115-a may determine (e.g., via a configuration or pre-configuration) that the UCI on different TRPs may be identical, combinable, or both.

In some examples, the UE 115-a may multiplex the UCI with the uplink shared channel using an encoding and rate matching scheme. The UE 115-a may determine the multiplexing and rate matching scheme according to one or more parameters such as a number of coded symbols per-layer for the UCI transmission (e.g., where a symbol is a dynamic scheduling unit for a time resource), the UCI omission for an UCI transmission, a rate matching output sequence length for different UCI, or any combination thereof. In some cases, the UE 115-a may omit one or more UCI bits, such as for different parts of channel state information (CSI) (e.g., CSI Part 1, CSI Part 2, or both). Similarly, the rate matching output sequence length may be different for a feedback message (e.g., an acknowledgement (ACK) or negative acknowledgment (NACK) (A/N)), the CSI Part 1, the CSI Part 2, or any combination thereof. The UE 115-a may determine one or more time-frequency resources for the UCI transmission in accordance with M_{sc}^{PUSCH}, which is a scheduled bandwidth of the uplink shared channel transmission and expressed as a number of subcarriers for an FDRA of a portion of the uplink shared channel transmission and the corresponding TRP, and M_{sc}^{UCI}(l), which is a number of resource elements that a UE 115-a may use for transmission of UCI in a symbol (e.g., an OFDM symbol) for an FDRA of a portion of the uplink shared channel transmission and the corresponding TRP. That is, the UE 115-a may determine a value for M_{sc}^{UCI}(l) based on performing FDRA splitting for different TRPs in the multi-TRP system 210.

The UE 115-a may determine the number of coded symbols per layer for the UCI transmission according to Equation 1:

$${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{SC}^{UCI} ( l )}{{\sum }_{r = 0}^{{C}_{UL - {SCH}^{- 1}}} {K}_{r}} ⌉ , ⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \} \qquad ( 1 )$$

where Q′_{CSI-2} is a number of coded symbols for CSI Part 2, Q′_{CSI-1} is a number of coded symbols for CSI Part 1, Q′_{ACK/CG-UCI} is a number of coded modulation symbols for an A/N with UCI, O_{CSI} is a number of CSI bits, L_{CSI} is a number of CRC bits for the CSI, β_{offset}^{PUSCH} is an offset number of bits for the PUSCH, N_{symb,all}^{PUSCH} is a total number of symbols allocated for the PUSCH, Kᵣ is an r-th code block size for an uplink shared channel of a PUSCH transmission, C_{UL-SCH} is a number of code blocks for the uplink shared channel of the PUSCH transmission, and α is configured by higher layer parameter scaling. The equation may be applied based on the portion of the uplink shared channel transmission associated with the corresponding TRP.

When the UE 115-a is scheduled to transmit a transport block (TB) on an uplink shared channel (e.g., not using repetition type B multiplexed with one or more CSI reports), the UE 115-a may omit CSI Part 2 when

$$⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{SC}^{UCI} ( l )}{{\sum }_{r = 0}^{{C}_{UL - {SCH}^{- 1}}} {K}_{r}} ⌉$$

is larger than

$$⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} .$$

In some cases, the UE 115-a may omit CSI Part 2 level by level, such as beginning with a lowest priority level (e.g., until the lowest priority level is reached), which causes the

$$⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{SC}^{UCI} ( l )}{{\sum }_{r = 0}^{{C}_{UL - {SCH}^{- 1}}} {K}_{r}} ⌉ t$$

be less than or equal to

$$⌈ α \cdot {\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} .$$

In some examples, once the UE 115-a multiplexes the UCI with the portions of the uplink shared channel, such as the uplink shared channel portion 230-a and the uplink shared channel portion 230-b, the UE 115-a may transmit an uplink shared channel with the UCI message 240 to the network entity 105-a via the TRPs (e.g., TRP 205-a and TRP 205-b). For example, the UE 115-a may transmit the uplink shared channel portion 230-a with UCI to the TRP 205-a using a TCI state specific to the TRP 205-a and the uplink shared channel portion 230-b with UCI to the TRP 205-b using a TCI state specific to the TRP 205-b. The TRP 205-a and the TRP 205-b may relay the uplink shared channel portion 230-a and the uplink shared channel portion 230-b to the network entity 105-a, respectively, via the communication link 125-a. The network entity 105-a may perform a decoding and rate matching procedure to obtain the information in the uplink shared channel and UCI.

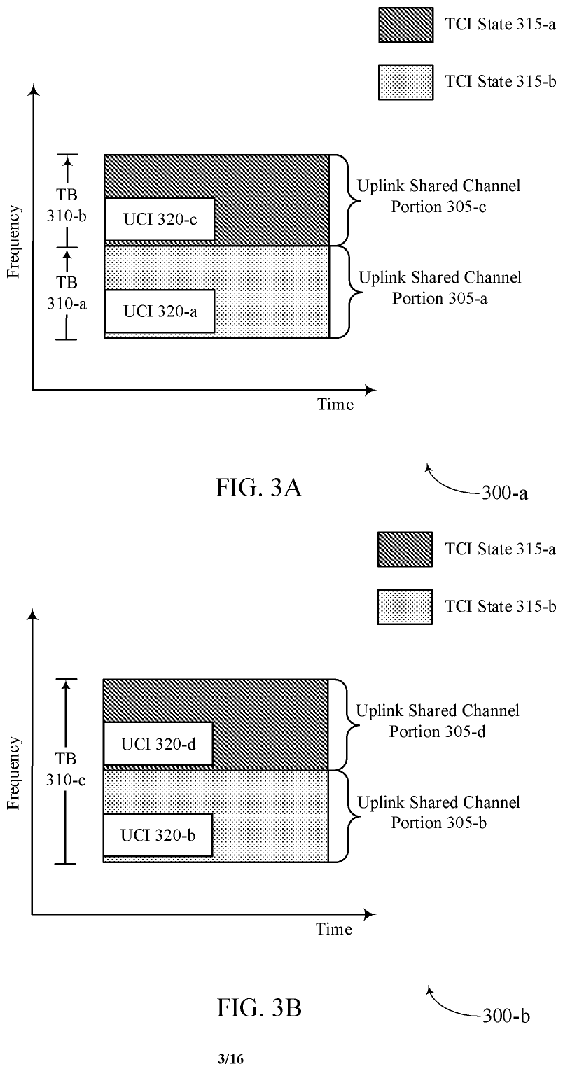

FIG. 3 illustrate examples of a resource diagram 300-a and a resource diagram 300-b, respectively, that support uplink multiplexing for multi-TRP operations in accordance with one or more aspects of the present disclosure. In some examples, the resource diagram 300-a and the resource diagram 300-b may implement aspects of wireless communications system 100 and wireless communications system 200. For example, the resource diagram 300-a and the resource diagram 300-b may be implemented by a wireless communications system in which a UE multiplexes UCI with different portions of an uplink shared channel for transmission to a network entity via multiple TRPs, where the network entity, TRPs, and UE may be examples of the corresponding devices as described with reference to FIGS. 1 and 2.

In some examples, a network entity may define one or more rules, or procedures, for a UE to support multiplexing UCI with an uplink shared channel for communications in a multi-TRP system. The network entity may transmit scheduling information to the UE to schedule one or more portions of the uplink shared channel message and to indicate one or more TCI states for the UE to use. For example, the scheduling information may indicate one or more FDRAs to the UE, which may indicate for the UE to use a portion of frequency resources for an uplink shared channel portion 305-a and an uplink shared channel portion 305-b and a different portion of frequency resources for an uplink shared channel portion 305-c and an uplink shared channel portion 305-d. The frequency resources may span one or more TBs. For example, as illustrated in FIG. 3A, the frequency resources for the uplink shared channel portion 305-a may span a TB 310-a, while the frequency resources for the uplink shared channel portion 305-c may span a TB 310-b. In some other examples, as illustrated in FIG. 3B, the frequency resources for the uplink shared channel portion 305-b and the uplink shared channel portion 305-d may span a single TB 310-c.

In some cases, such as for FIG. 3A, the scheduling indication may map TBs to uplink shared channel portions based on one or more RVs of the uplink shared channel. For example, the uplink shared channel portion 305-a may include a first RV of the uplink shared channel and the uplink shared channel portion 305-c may include a second RV of the uplink shared channel. Thus, the network entity may configure the UE to use a TB 310-a for the first RV and a TB 310-b for the second RV of the uplink shared channel (e.g., the uplink shared channel portion 305-a and the uplink shared channel portion 305-c). In some other cases, such as for FIG. 3B, the scheduling indication may map one TB consecutively for the uplink shared channel portions when the uplink shared channel portions are not different RVs, such that the TB 310-c may span the uplink shared channel portion 305-b and the uplink shared channel portion 305-d.

In some examples, the scheduling indication may indicate for the UE to use a TCI state 315-a for an uplink shared channel portion 305-c or an uplink shared channel portion 305-d to a first TRP and a TCI state 315-b for an uplink shared channel portion 305-a or an uplink shared channel portion 305-b to a second TRP. That is, the UE may use different TCI states for transmissions to different TRPs to increase beam diversity, which may achieve higher reliability at the UE. The UE may generate one or more UCI bits based on the uplink shared channel. For example, the UE may generate one or more bits for UCI 320-a for the uplink shared channel portion 305-a, UCI 320-b for the uplink shared channel portion 305-b, UCI 320-c for the uplink shared channel portion 305-c, and UCI 320-d for the uplink shared channel portion 305-d. In some examples, generating the UCI bits may include copying a single set of bits, splitting UCI bits into multiple different sets, or both. The UE may omit one or more of the bits for a rate matching sequence, which may be propagated to each copied set of UCI bits. The rate matching sequence, including the UCI omission, may be calculated according to Equation 1, as described with reference to FIG. 1.

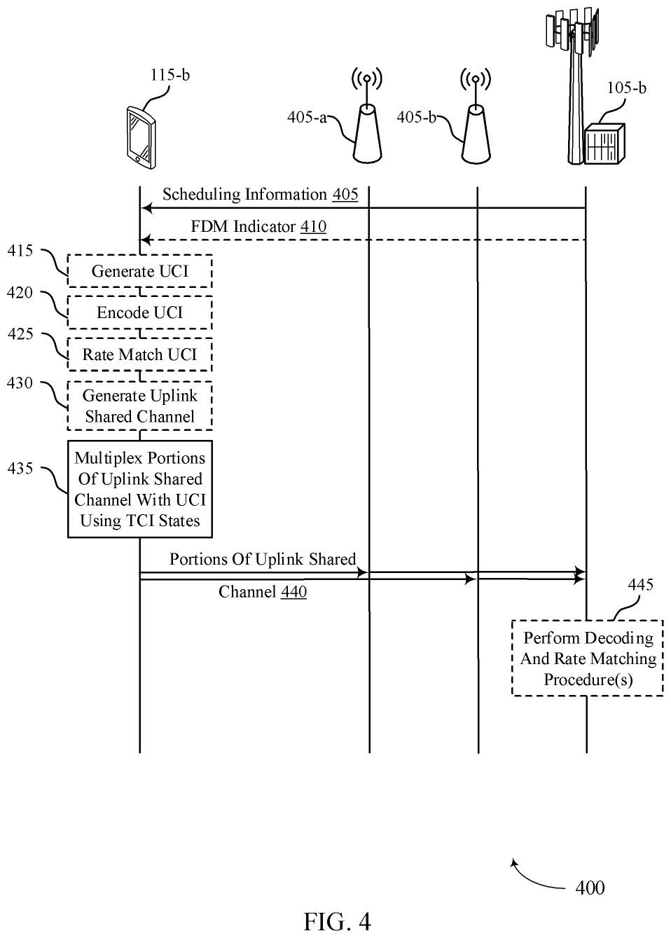

FIG. 4 illustrates an example of a process flow 400 that supports uplink multiplexing for multi-TRP operations in accordance with one or more aspects of the present disclosure. In some examples, the process flow 400 may implement aspects of wireless communications system 100, wireless communications system 200, resource diagram 300-a, and resource diagram 300-b. The process flow 400 may illustrate an example of a UE 115-b multiplexing UCI with different portions of an uplink shared channel for transmission to a network entity 105-b via multiple TRPs (e.g., a TRP 405-a and a TRP 405-b). The network entity 105-b, the TRP 405-a, the TRP 405-b, and the UE 115-b may be examples of a network entity 105, TRPs 205, and a UE 115 as described with reference to FIGS. 1 and 2. Alternative examples of the following may be implemented, where some processes are performed in a different order than described or are not performed. In some cases, processes may include additional features not mentioned below, or further processes may be added.

At 405, a network entity 105-b may transmit a control message (e.g., a DCI message) indicating scheduling information for an uplink shared channel for a UE 115-b. The scheduling information may include multiple TCI states for the uplink shared channel. For example, the scheduling information may include a TCI state for a first portion of the uplink shared channel to a TRP 405-a and a different TCI state for a second portion of the uplink shared channel to a TRP 405-b. In some cases, the UE 115-b may split the uplink shared channel into the first portion and the second portion based on a ceiling function and a floor function, respectively, and a number of resource blocks allocated to the uplink shared channel (e.g., in the scheduling information).

In some cases, at 410, the network entity 105-b may transmit an additional control message configuring the UE 115-b to operate in an FDM mode for uplink shared channel transmissions. The additional control message may be an additional DCI message, or may be included in the DCI message carrying the scheduling information. Additionally, or alternatively, the network entity 105-b may transmit the FDM indicator prior to the scheduling information, such as in RRC signaling, a MAC-CE, or the like.

In some examples, at 415, the UE 115-b may generate UCI based on receiving the scheduling information. For example, the UE 115-b may generate UCI for the second portion of the uplink shared channel based on UCI for the first portion of the uplink shared channel, such as by copying the UCI for the first portion of the uplink shared channel.

At 420, the UE 115-b may encode the UCI. For example, the UE 115-b may encode first UCI for multiplexing with the first portion of the uplink shared channel using a set of encoding parameters for a respective TCI state (e.g., assigned to the first portion of the uplink shared channel). The UE 115-b may generate second UCI for multiplexing with the second portion of the uplink shared channel based on encoding the first UCI. Additionally, or alternatively, the UE 115-b may encode the first UCI for multiplexing with the first portion of the uplink shared channel using an encoding scheme different from an encoding scheme for second UCI for multiplexing with the second portion of the uplink shared channel. The first UCI and the second UCI may have the same UCI payload (e.g., the same set of A/N bits, the same set of CSI reports, or both).

At 425, the UE 115-b may rate match the UCI after encoding, as a part of a rate matching and encoding procedure, or both. For example, the UE 115-b may perform rate matching for the first UCI using a rate matching scheme for a TCI for the first portion of the uplink shared channel. The UE 115-b may generate second UCI for multiplexing with the second portion of the uplink shared channel based on rate matching the first UCI. Additionally, or alternatively, the UE 115-b may rate match the first UCI after encoding the first UCI using a rate matching scheme different from a rate matching scheme for the second UCI.

In some cases, the UE 115-b may perform an encoding and rate matching procedure to obtain the first UCI using an encoding and rate matching scheme for a respective TCI state (e.g., assigned to the first portion of the uplink shared channel). For example, the UE 115-b may determine a number of coded symbols per layer for the first UCI, omit one or more bits of the first UCI, and may determine one or more sequence lengths for different subsets of information of the first UCI after omitting the one or more bits (e.g., in accordance with Equation 1). Similarly, the UE 115-b may perform an encoding and rate matching procedure to obtain the second UCI using a different encoding and rate matching scheme. The UE 115-b may determine a number of coded symbols per layer for the second UCI, omit one or more bits of the second UCI, and may determine one or more sequence lengths for different subsets of information of the second UCI after omitting the one or more bits (e.g., in accordance with Equation 1).

At 430, the UE 115-b may generate an uplink shared channel for transmission to the TRP 405-a, the TRP 405-b, or both. For example, the UE 115-b may generate the first portion of the uplink shared channel with a first RV and the second portion of the uplink shared channel with a second RV (e.g., different from the first RV) of the uplink shared channel. In some other examples, the UE 115-b may generate the first portion and second portion of the uplink shared channel with a same RV (e.g., continuous across the uplink shared channel portions).

At 435, the UE 115-b may multiplex the portions of the uplink shared channel (e.g., the first portion and the second portion of the uplink shared channel) with UCI according to different TCI states. For example, the UE 115-b may multiplex the first UCI with the first portion of the uplink shared channel after performing rate matching for the first UCI. Similarly, the UE 115-b may multiplex the second UCI with the second portion of the uplink shared channel after performing rate matching for the second UCI.

At 440, the UE 115-b may transmit the first portion of the uplink shared channel multiplexed with the first UCI to the network entity 105-b using a TCI state for the TRP 405-a. The UE 115-b may transmit the first portion of the uplink shared channel using a set of time-frequency resources, where the time resources overlap with a second transmission of a second portion of the uplink shared channel. The time-frequency resources may not overlap in frequency. The UE 115-b may transmit the second portion of the uplink shared channel multiplexed with the second UCI to the network entity 105-b using a TCI state for the TRP 405-b. In some examples, the TRP 405-a and the TRP 405-b may relay the first portion and the second portion of the uplink shared channel to the network entity 105-b. In some other examples, the TRP 405-a and the TRP 405-b may function as a network entity.

At 445, the network entity 105-b may perform a decoding procedure, a rate matching procedure, or both for the first UCI, the second UCI, or both based on the encoding and rate matching scheme the UE 115-b used for respective TCI states (e.g., a TCI state for the TRP 405-a and a TCI state for the TRP 405-b). Each TCI state may indicate a respective beam for the UE 115-b to use when transmitting the portions of the uplink shared channels multiplexed with the UCI. In some cases, the first UCI and the second UCI may be the same if the UE 115-b generates the second UCI by copying the first UCI.

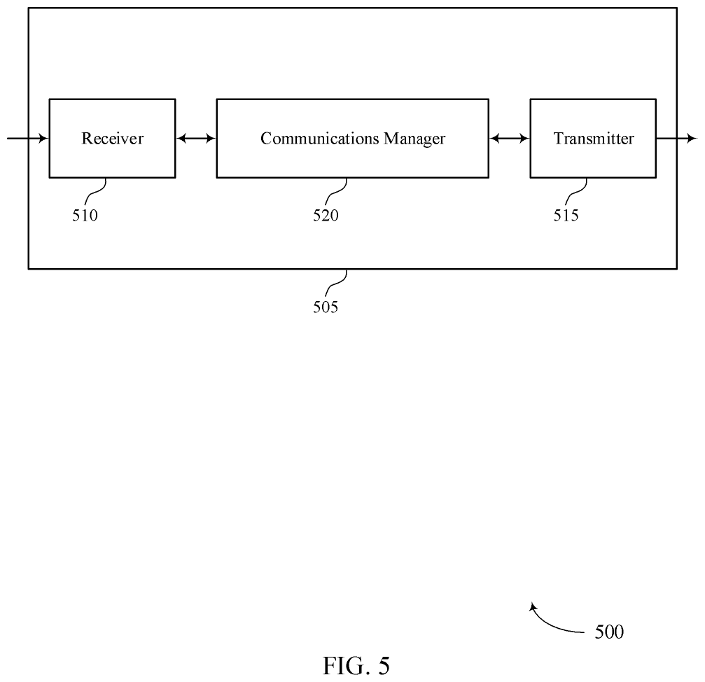

FIG. 5 shows a block diagram 500 of a device 505 that supports uplink multiplexing for multi-TRP operations in accordance with one or more aspects of the present disclosure. The device 505 may be an example of aspects of a UE 115 as described herein. The device 505 may include a receiver 510, a transmitter 515, and a communications manager 520. The device 505 may also include a processor. Each of these components may be in communication with one another (e.g., via one or more buses).

The receiver 510 may provide a means for receiving information such as packets, user data, control information, or any combination thereof associated with various information channels (e.g., control channels, data channels, information channels related to uplink multiplexing for multi-TRP operations). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to uplink multiplexing for multi-TRP operations). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of uplink multiplexing for multi-TRP operations as described herein. For example, the communications manager 520, the receiver 510, the transmitter 515, or various combinations or components thereof may support a method for performing one or more of the functions described herein.

In some examples, the communications manager 520, the receiver 510, the transmitter 515, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 520, the receiver 510, the transmitter 515, or various combinations or components thereof may be implemented in code (e.g., as communications management software or firmware) executed by a processor. If implemented in code executed by a processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 may be configured as or otherwise support a means for receiving a control message indicating scheduling information for an uplink shared channel for the UE, the scheduling information indicating multiple TCI states for the uplink shared channel. The communications manager 520 may be configured as or otherwise support a means for transmitting, via a first set of resources, a first portion of the uplink shared channel multiplexed with first UCI in accordance with a first TCI state of the multiple TCI states. The communications manager 520 may be configured as or otherwise support a means for transmitting, via a second set of resources that at least partially overlaps the first set of resources in time, a second portion of the uplink shared channel multiplexed with second UCI in accordance with a second TCI state of the multiple TCI states.

By including or configuring the communications manager 520 in accordance with examples as described herein, the device 505 (e.g., a processor controlling or otherwise coupled with the receiver 510, the transmitter 515, the communications manager 520, or a combination thereof) may support techniques for a UE to multiplex UCI with different portions of an uplink shared channel for transmission to a network entity via multiple TRPs, which may provide for reduced processing, reduced power consumption, more efficient utilization of communication resources, and the like.

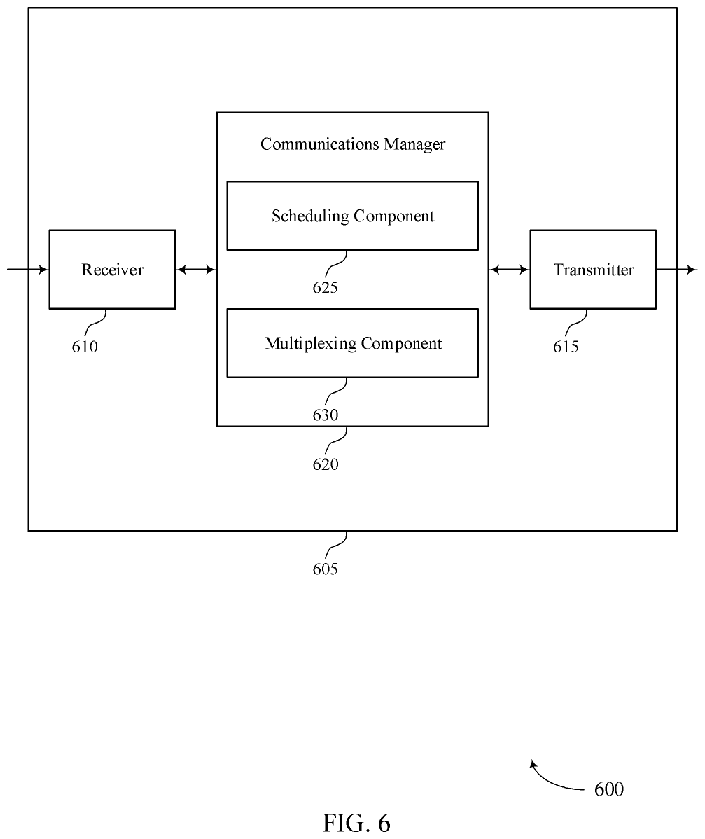

FIG. 6 shows a block diagram 600 of a device 605 that supports uplink multiplexing for multi-TRP operations in accordance with one or more aspects of the present disclosure. The device 605 may be an example of aspects of a device 505 or a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to uplink multiplexing for multi-TRP operations). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to uplink multiplexing for multi-TRP operations). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of uplink multiplexing for multi-TRP operations as described herein. For example, the communications manager 620 may include a scheduling component 625 a multiplexing component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The scheduling component 625 may be configured as or otherwise support a means for receiving a control message indicating scheduling information for an uplink shared channel for the UE, the scheduling information indicating multiple TCI states for the uplink shared channel. The multiplexing component 630 may be configured as or otherwise support a means for transmitting, via a first set of resources, a first portion of the uplink shared channel multiplexed with first UCI in accordance with a first TCI state of the multiple TCI states. The multiplexing component 630 may be configured as or otherwise support a means for transmitting, via a second set of resources that at least partially overlaps the first set of resources in time, a second portion of the uplink shared channel multiplexed with second UCI in accordance with a second TCI state of the multiple TCI states.

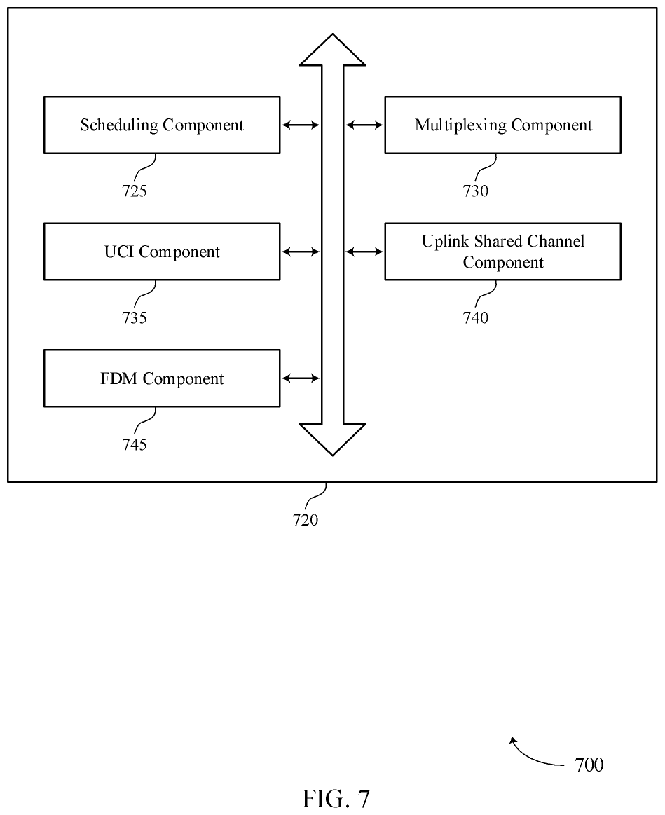

FIG. 7 shows a block diagram 700 of a communications manager 720 that supports uplink multiplexing for multi-TRP operations in accordance with one or more aspects of the present disclosure. The communications manager 720 may be an example of aspects of a communications manager 520, a communications manager 620, or both, as described herein. The communications manager 720, or various components thereof, may be an example of means for performing various aspects of uplink multiplexing for multi-TRP operations as described herein. For example, the communications manager 720 may include a scheduling component 725, a multiplexing component 730, a UCI component 735, an uplink shared channel component 740, an FDM component 745, or any combination thereof. Each of these components may communicate, directly or indirectly, with one another (e.g., via one or more buses).

The communications manager 720 may support wireless communications at a UE in accordance with examples as disclosed herein. The scheduling component 725 may be configured as or otherwise support a means for receiving a control message indicating scheduling information for an uplink shared channel for the UE, the scheduling information indicating multiple TCI states for the uplink shared channel. The multiplexing component 730 may be configured as or otherwise support a means for transmitting, via a first set of resources, a first portion of the uplink shared channel multiplexed with first UCI in accordance with a first TCI state of the multiple TCI states. In some examples, the multiplexing component 730 may be configured as or otherwise support a means for transmitting, via a second set of resources that at least partially overlaps the first set of resources in time, a second portion of the uplink shared channel multiplexed with second UCI in accordance with a second TCI state of the multiple TCI states.

In some examples, the UCI component 735 may be configured as or otherwise support a means for generating the second UCI based on the first UCI, where the second UCI is a copy of the first UCI.

In some examples, the UCI component 735 may be configured as or otherwise support a means for encoding the first UCI according to a set of encoding parameters associated with the first TCI state, where the second UCI is generated based on the encoded first UCI.

In some examples, the UCI component 735 may be configured as or otherwise support a means for performing rate matching for the first UCI according to a rate matching scheme associated with the first TCI state, where the second UCI is generated based on the rate matched first UCI.

In some examples, the multiplexing component 730 may be configured as or otherwise support a means for encoding the first UCI according to a first encoding scheme. In some examples, the multiplexing component 730 may be configured as or otherwise support a means for performing, after encoding the first UCI, rate matching for the first UCI according to a first rate matching scheme. In some examples, the multiplexing component 730 may be configured as or otherwise support a means for multiplexing the first UCI with the first portion of the uplink shared channel after performing rate matching for the first UCI.

In some examples, the multiplexing component 730 may be configured as or otherwise support a means for encoding the second UCI according to a second encoding scheme. In some examples, the multiplexing component 730 may be configured as or otherwise support a means for performing, after encoding the second UCI, rate matching for the second UCI according to a second rate matching scheme. In some examples, the multiplexing component 730 may be configured as or otherwise support a means for multiplexing the second UCI with the second portion of the uplink shared channel after performing rate matching for the second UCI.

In some examples, the first encoding scheme is different from the second encoding scheme.

In some examples, the first rate matching scheme is different from the second rate matching scheme.

In some examples, the multiplexing component 730 may be configured as or otherwise support a means for performing an encoding and rate matching procedure for a first set of UCI based on a first encoding and rate matching scheme associated with the first TCI state to obtain the first UCI.

In some examples, to support performing the encoding and rate matching procedure for the first set of UCI, the UCI component 735 may be configured as or otherwise support a means for determining a number of coded symbols per layer for the first set of UCI. In some examples, to support performing the encoding and rate matching procedure for the first set of UCI, the UCI component 735 may be configured as or otherwise support a means for omitting one or more bits of the first set of UCI. In some examples, to support performing the encoding and rate matching procedure for the first set of UCI, the UCI component 735 may be configured as or otherwise support a means for determining one or more sequence lengths for different subsets of information of the first set of UCI after omitting the one or more bits.

In some examples, the multiplexing component 730 may be configured as or otherwise support a means for performing an encoding and rate matching procedure for a second set of UCI based on an encoding and rate matching scheme to obtain the second UCI.

In some examples, to support performing the encoding and rate matching procedure for the second set of UCI, the UCI component 735 may be configured as or otherwise support a means for determining a number of coded symbols per layer for the second set of UCI. In some examples, to support performing the encoding and rate matching procedure for the second set of UCI, the UCI component 735 may be configured as or otherwise support a means for omitting one or more bits of the second set of UCI. In some examples, to support performing the encoding and rate matching procedure for the second set of UCI, the UCI component 735 may be configured as or otherwise support a means for determining one or more sequence lengths for different subsets of information of the second set of UCI after omitting the one or more bits.

In some examples, the uplink shared channel component 740 may be configured as or otherwise support a means for generating the first portion of the uplink shared channel based on a first redundancy version. In some examples, the uplink shared channel component 740 may be configured as or otherwise support a means for generating the second portion of the uplink shared channel based on a second redundancy version different from the first redundancy version.

In some examples, the uplink shared channel component 740 may be configured as or otherwise support a means for generating the first portion and the second portion of the uplink shared channel based on a same redundancy version.

In some examples, the FDM component 745 may be configured as or otherwise support a means for receiving a second control message configuring the UE to operate in a frequency division multiplexed mode for uplink shared channel transmissions.

In some examples, the uplink shared channel component 740 may be configured as or otherwise support a means for splitting the uplink shared channel into the first portion based on a ceiling function and a number of resource blocks associated with the uplink shared channel. In some examples, the uplink shared channel component 740 may be configured as or otherwise support a means for splitting the uplink shared channel into the second portion based on a floor function and the number of resource blocks associated with the uplink shared channel.

In some examples, the first set of resources and the second set of resources are non-overlapping in frequency.

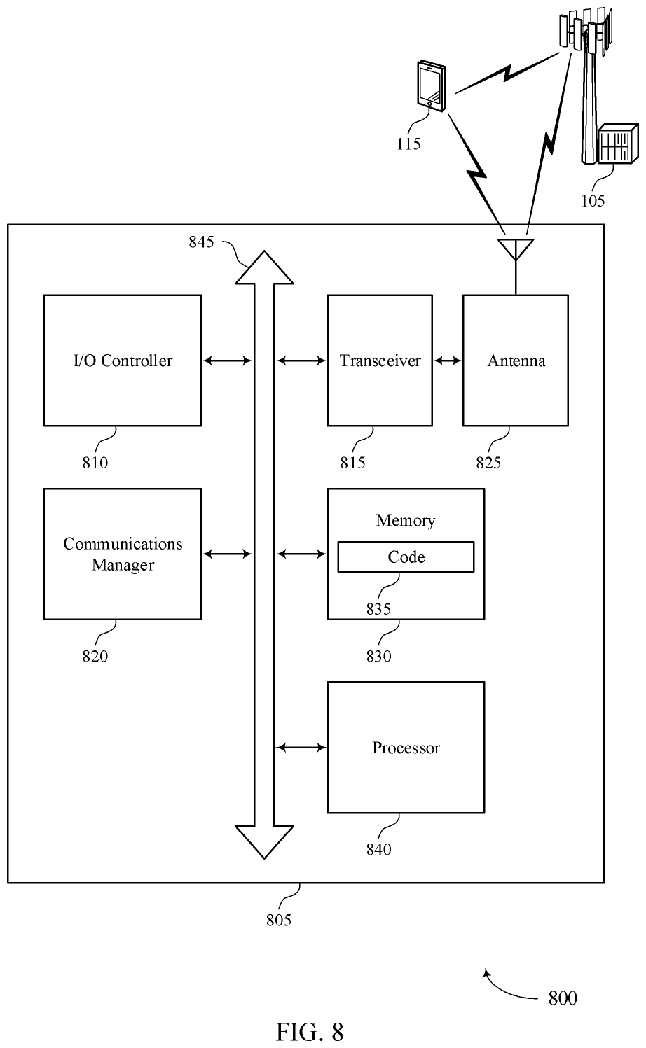

FIG. 8 shows a diagram of a system 800 including a device 805 that supports uplink multiplexing for multi-TRP operations in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting uplink multiplexing for multi-TRP operations). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 may be configured as or otherwise support a means for receiving a control message indicating scheduling information for an uplink shared channel for the UE, the scheduling information indicating multiple TCI states for the uplink shared channel. The communications manager 820 may be configured as or otherwise support a means for transmitting, via a first set of resources, a first portion of the uplink shared channel multiplexed with first UCI in accordance with a first TCI state of the multiple TCI states. The communications manager 820 may be configured as or otherwise support a means for transmitting, via a second set of resources that at least partially overlaps the first set of resources in time, a second portion of the uplink shared channel multiplexed with second UCI in accordance with a second TCI state of the multiple TCI states.

By including or configuring the communications manager 820 in accordance with examples as described herein, the device 805 may support techniques for a UE to multiplex UCI with different portions of an uplink shared channel for transmission to a network entity via multiple TRPs, which may provide for improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of uplink multiplexing for multi-TRP operations as described herein, or the processor 840 and the memory 830 may be otherwise configured to perform or support such operations.

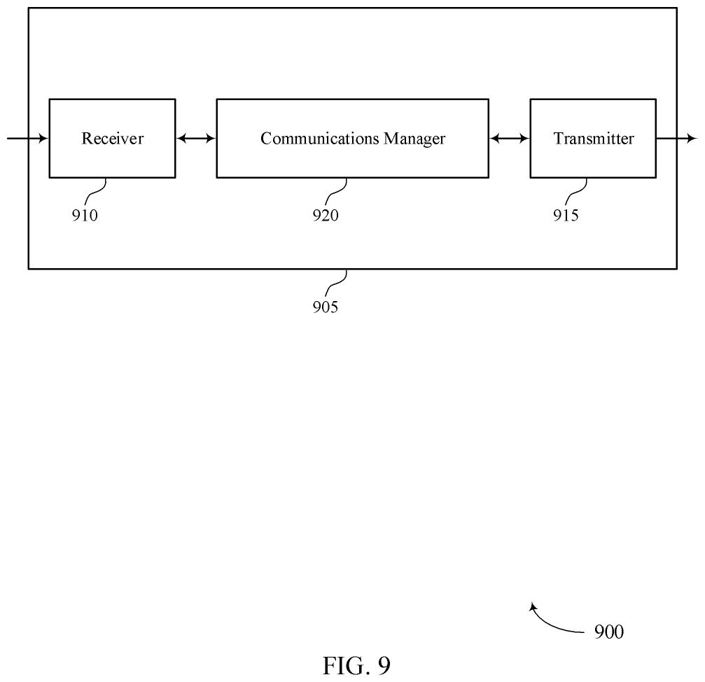

FIG. 9 shows a block diagram 900 of a device 905 that supports uplink multiplexing for multi-TRP operations in accordance with one or more aspects of the present disclosure. The device 905 may be an example of aspects of a network entity 105 as described herein. The device 905 may include a receiver 910, a transmitter 915, and a communications manager 920. The device 905 may also include a processor. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of uplink multiplexing for multi-TRP operations as described herein. For example, the communications manager 920, the receiver 910, the transmitter 915, or various combinations or components thereof may support a method for performing one or more of the functions described herein.

In some examples, the communications manager 920, the receiver 910, the transmitter 915, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 920, the receiver 910, the transmitter 915, or various combinations or components thereof may be implemented in code (e.g., as communications management software or firmware) executed by a processor. If implemented in code executed by a processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 may be configured as or otherwise support a means for transmitting a control message indicating scheduling information for an uplink shared channel for a UE, the scheduling information indicating multiple TCI states for the uplink shared channel. The communications manager 920 may be configured as or otherwise support a means for receiving, via a first set of resources, a first portion of the uplink shared channel multiplexed with first UCI in accordance with a first TCI state of the multiple TCI states. The communications manager 920 may be configured as or otherwise support a means for receiving, via a second set of resources that at least partially overlaps the first set of resources in time, a second portion of the uplink shared channel multiplexed with second UCI in accordance with a second TCI state of the multiple TCI states.

By including or configuring the communications manager 920 in accordance with examples as described herein, the device 905 (e.g., a processor controlling or otherwise coupled with the receiver 910, the transmitter 915, the communications manager 920, or a combination thereof) may support techniques for a UE to multiplex UCI with different portions of an uplink shared channel for transmission to a network entity via multiple TRPs, which may provide for reduced processing, reduced power consumption, more efficient utilization of communication resources, and the like.

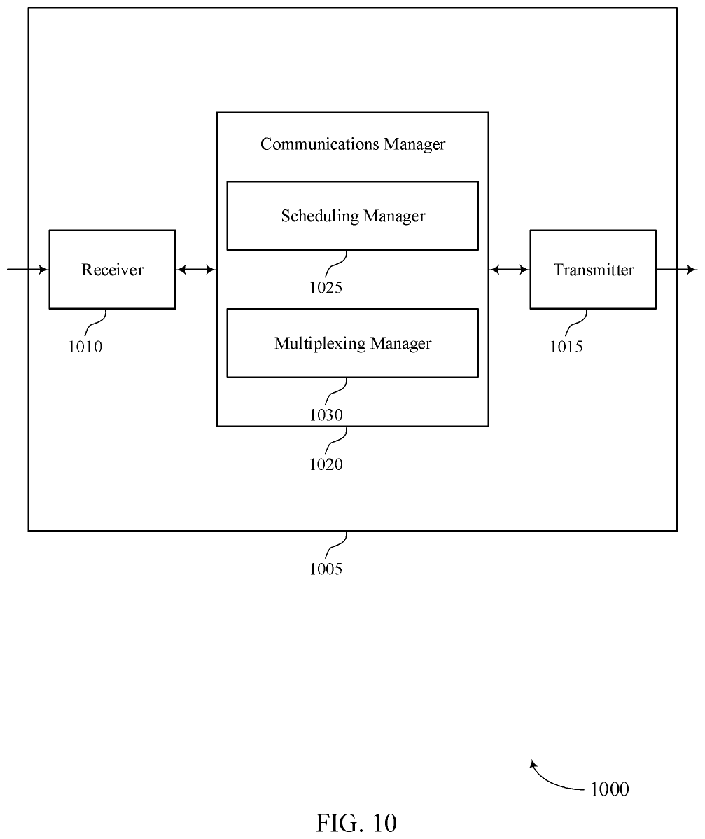

FIG. 10 shows a block diagram 1000 of a device 1005 that supports uplink multiplexing for multi-TRP operations in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of uplink multiplexing for multi-TRP operations as described herein. For example, the communications manager 1020 may include a scheduling manager 1025 a multiplexing manager 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The scheduling manager 1025 may be configured as or otherwise support a means for transmitting a control message indicating scheduling information for an uplink shared channel for a UE, the scheduling information indicating multiple TCI states for the uplink shared channel. The multiplexing manager 1030 may be configured as or otherwise support a means for receiving, via a first set of resources, a first portion of the uplink shared channel multiplexed with first UCI in accordance with a first TCI state of the multiple TCI states. The multiplexing manager 1030 may be configured as or otherwise support a means for receiving, via a second set of resources that at least partially overlaps the first set of resources in time, a second portion of the uplink shared channel multiplexed with second UCI in accordance with a second TCI state of the multiple TCI states.

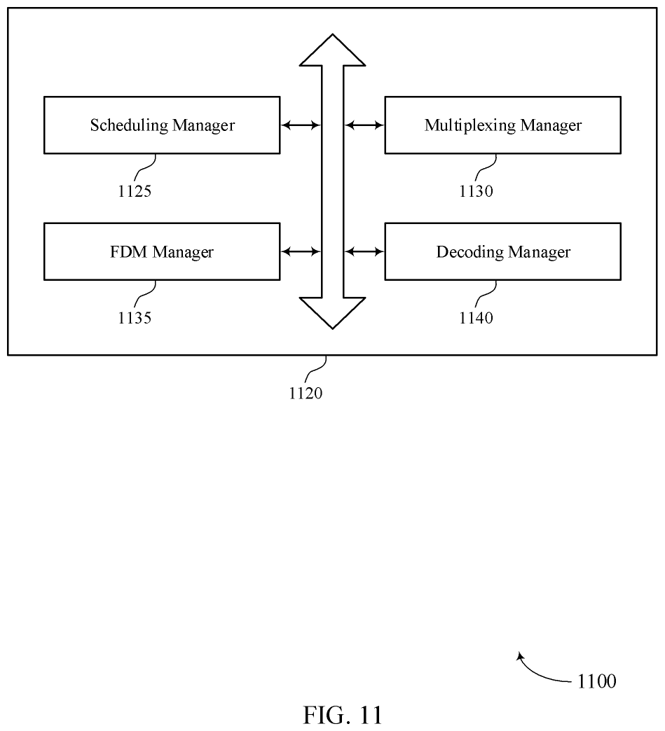

FIG. 11 shows a block diagram 1100 of a communications manager 1120 that supports uplink multiplexing for multi-TRP operations in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of uplink multiplexing for multi-TRP operations as described herein. For example, the communications manager 1120 may include a scheduling manager 1125, a multiplexing manager 1130, an FDM manager 1135, a decoding manager 1140, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The scheduling manager 1125 may be configured as or otherwise support a means for transmitting a control message indicating scheduling information for an uplink shared channel for a UE, the scheduling information indicating multiple TCI states for the uplink shared channel. The multiplexing manager 1130 may be configured as or otherwise support a means for receiving, via a first set of resources, a first portion of the uplink shared channel multiplexed with first UCI in accordance with a first TCI state of the multiple TCI states. In some examples, the multiplexing manager 1130 may be configured as or otherwise support a means for receiving, via a second set of resources that at least partially overlaps the first set of resources in time, a second portion of the uplink shared channel multiplexed with second UCI in accordance with a second TCI state of the multiple TCI states.

In some examples, the FDM manager 1135 may be configured as or otherwise support a means for transmitting a second control message configuring the UE to operate in a frequency division multiplexed mode for uplink shared channel transmissions.

In some examples, the decoding manager 1140 may be configured as or otherwise support a means for performing a decoding and rate matching procedure for the first UCI based on a first encoding and rate matching scheme associated with the first TCI state. In some examples, the decoding manager 1140 may be configured as or otherwise support a means for performing the decoding and rate matching procedure for the second UCI based on the first encoding and rate matching scheme associated with the first TCI state.

In some examples, the first UCI and the second UCI are the same.

In some examples, the decoding manager 1140 may be configured as or otherwise support a means for performing a first decoding and rate matching procedure for the first UCI based on a first encoding and rate matching scheme associated with the first TCI state.

In some examples, the decoding manager 1140 may be configured as or otherwise support a means for performing a second decoding and rate matching procedure for the second UCI based on a second encoding and rate matching scheme associated with the second TCI state.

In some examples, the first UCI and the second UCI are different.

In some examples, the first set of resources and the second set of resources are non-overlapping in frequency.

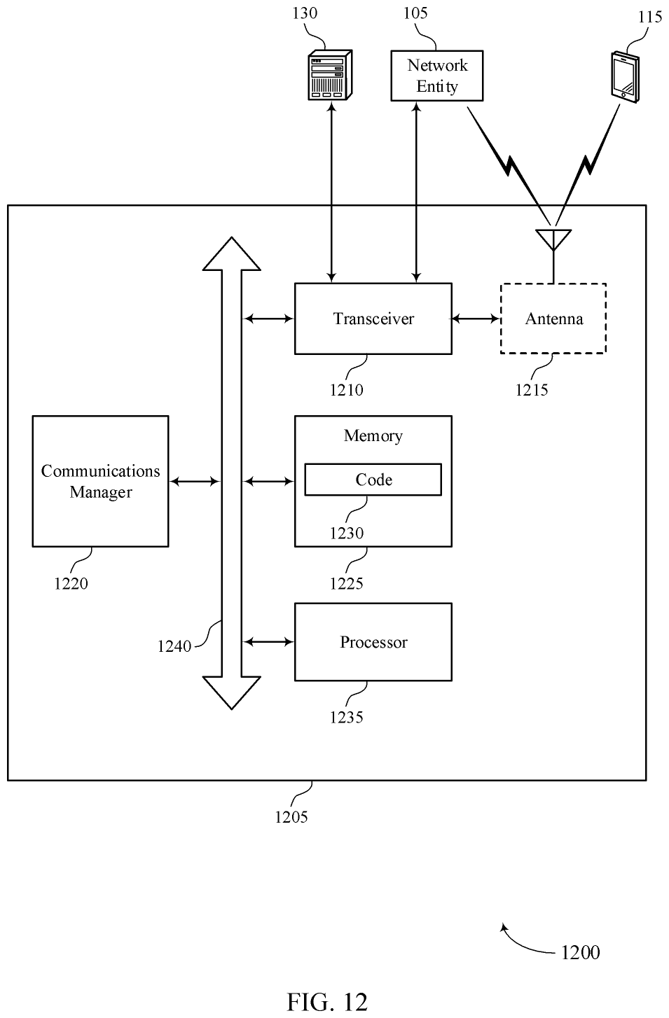

FIG. 12 shows a diagram of a system 1200 including a device 1205 that supports uplink multiplexing for multi-TRP operations in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. The transceiver 1210, or the transceiver 1210 and one or more antennas 1215 or wired interfaces, where applicable, may be an example of a transmitter 915, a transmitter 1015, a receiver 910, a receiver 1010, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting uplink multiplexing for multi-TRP operations). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 may be configured as or otherwise support a means for transmitting a control message indicating scheduling information for an uplink shared channel for a UE, the scheduling information indicating multiple TCI states for the uplink shared channel. The communications manager 1220 may be configured as or otherwise support a means for receiving, via a first set of resources, a first portion of the uplink shared channel multiplexed with first UCI in accordance with a first TCI state of the multiple TCI states. The communications manager 1220 may be configured as or otherwise support a means for receiving, via a second set of resources that at least partially overlaps the first set of resources in time, a second portion of the uplink shared channel multiplexed with second UCI in accordance with a second TCI state of the multiple TCI states.

By including or configuring the communications manager 1220 in accordance with examples as described herein, the device 1205 may support techniques for a UE to multiplex UCI with different portions of an uplink shared channel for transmission to a network entity via multiple TRPs, which may provide for improved communication reliability, reduced latency, improved user experience related to reduced processing, reduced power consumption, more efficient utilization of communication resources, improved coordination between devices, longer battery life, improved utilization of processing capability, and the like.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the processor 1235, the memory 1225, the code 1230, the transceiver 1210, or any combination thereof. For example, the code 1230 may include instructions executable by the processor 1235 to cause the device 1205 to perform various aspects of uplink multiplexing for multi-TRP operations as described herein, or the processor 1235 and the memory 1225 may be otherwise configured to perform or support such operations.

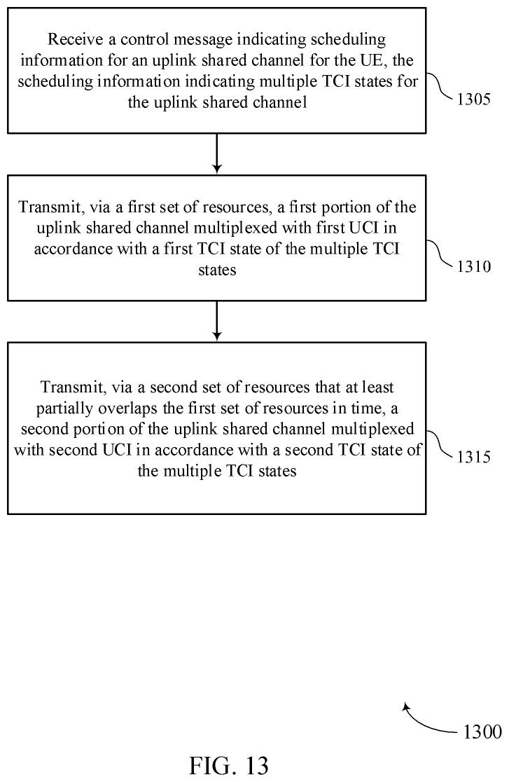

FIG. 13 shows a flowchart illustrating a method 1300 that supports uplink multiplexing for multi-TRP operations in accordance with one or more aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving a control message indicating scheduling information for an uplink shared channel for the UE, the scheduling information indicating multiple TCI states for the uplink shared channel. The operations of 1305 may be performed in accordance with examples as disclosed herein. In some examples, aspects of the operations of 1305 may be performed by a scheduling component 725 as described with reference to FIG. 7.

At 1310, the method may include transmitting, via a first set of resources, a first portion of the uplink shared channel multiplexed with first UCI in accordance with a first TCI state of the multiple TCI states. The operations of 1310 may be performed in accordance with examples as disclosed herein. In some examples, aspects of the operations of 1310 may be performed by a multiplexing component 730 as described with reference to FIG. 7.

At 1315, the method may include transmitting, via a second set of resources that at least partially overlaps the first set of resources in time, a second portion of the uplink shared channel multiplexed with second UCI in accordance with a second TCI state of the multiple TCI states. The operations of 1315 may be performed in accordance with examples as disclosed herein. In some examples, aspects of the operations of 1315 may be performed by a multiplexing component 730 as described with reference to FIG. 7.

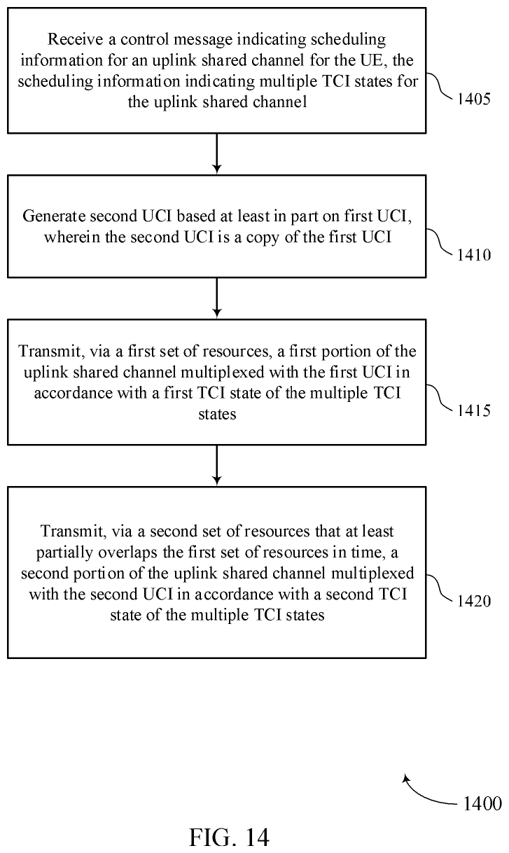

FIG. 14 shows a flowchart illustrating a method 1400 that supports uplink multiplexing for multi-TRP operations in accordance with one or more aspects of the present disclosure. The operations of the method 1400 may be implemented by a UE or its components as described herein. For example, the operations of the method 1400 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1405, the method may include receiving a control message indicating scheduling information for an uplink shared channel for the UE, the scheduling information indicating multiple TCI states for the uplink shared channel. The operations of 1405 may be performed in accordance with examples as disclosed herein. In some examples, aspects of the operations of 1405 may be performed by a scheduling component 725 as described with reference to FIG. 7.

At 1410, the method may include generating second UCI based on first UCI, where the second UCI is a copy of the first UCI. The operations of 1410 may be performed in accordance with examples as disclosed herein. In some examples, aspects of the operations of 1410 may be performed by a UCI component 735 as described with reference to FIG. 7.

At 1415, the method may include transmitting, via a first set of resources, a first portion of the uplink shared channel multiplexed with the first UCI in accordance with a first TCI state of the multiple TCI states. The operations of 1415 may be performed in accordance with examples as disclosed herein. In some examples, aspects of the operations of 1415 may be performed by a multiplexing component 730 as described with reference to FIG. 7.

At 1420, the method may include transmitting, via a second set of resources that at least partially overlaps the first set of resources in time, a second portion of the uplink shared channel multiplexed with the second UCI in accordance with a second TCI state of the multiple TCI states. The operations of 1420 may be performed in accordance with examples as disclosed herein. In some examples, aspects of the operations of 1420 may be performed by a multiplexing component 730 as described with reference to FIG. 7.

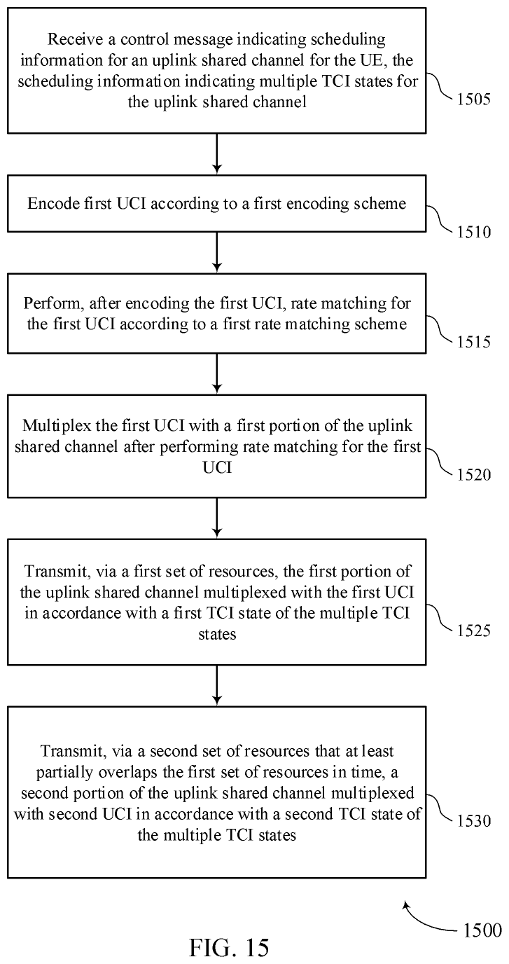

FIG. 15 shows a flowchart illustrating a method 1500 that supports uplink multiplexing for multi-TRP operations in accordance with one or more aspects of the present disclosure. The operations of the method 1500 may be implemented by a UE or its components as described herein. For example, the operations of the method 1500 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1505, the method may include receiving a control message indicating scheduling information for an uplink shared channel for the UE, the scheduling information indicating multiple TCI states for the uplink shared channel. The operations of 1505 may be performed in accordance with examples as disclosed herein. In some examples, aspects of the operations of 1505 may be performed by a scheduling component 725 as described with reference to FIG. 7.

At 1510, the method may include encoding first UCI according to a first encoding scheme. The operations of 1510 may be performed in accordance with examples as disclosed herein. In some examples, aspects of the operations of 1510 may be performed by a multiplexing component 730 as described with reference to FIG. 7.

At 1515, the method may include performing, after encoding the first UCI, rate matching for the first UCI according to a first rate matching scheme. The operations of 1515 may be performed in accordance with examples as disclosed herein. In some examples, aspects of the operations of 1515 may be performed by a multiplexing component 730 as described with reference to FIG. 7.

At 1520, the method may include multiplexing the first UCI with a first portion of the uplink shared channel after performing rate matching for the first UCI. The operations of 1520 may be performed in accordance with examples as disclosed herein. In some examples, aspects of the operations of 1520 may be performed by a multiplexing component 730 as described with reference to FIG. 7.

At 1525, the method may include transmitting, via a first set of resources, the first portion of the uplink shared channel multiplexed with the first UCI in accordance with a first TCI state of the multiple TCI states. The operations of 1525 may be performed in accordance with examples as disclosed herein. In some examples, aspects of the operations of 1525 may be performed by a multiplexing component 730 as described with reference to FIG. 7.

At 1530, the method may include transmitting, via a second set of resources that at least partially overlaps the first set of resources in time, a second portion of the uplink shared channel multiplexed with second UCI in accordance with a second TCI state of the multiple TCI states. The operations of 1530 may be performed in accordance with examples as disclosed herein. In some examples, aspects of the operations of 1530 may be performed by a multiplexing component 730 as described with reference to FIG. 7.

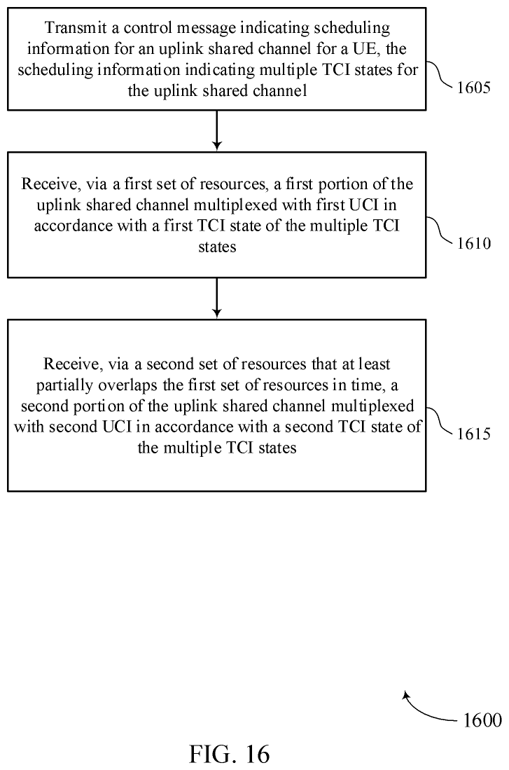

FIG. 16 shows a flowchart illustrating a method 1600 that supports uplink multiplexing for multi-TRP operations in accordance with one or more aspects of the present disclosure. The operations of the method 1600 may be implemented by a network entity or its components as described herein. For example, the operations of the method 1600 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1605, the method may include transmitting a control message indicating scheduling information for an uplink shared channel for a UE, the scheduling information indicating multiple TCI states for the uplink shared channel. The operations of 1605 may be performed in accordance with examples as disclosed herein. In some examples, aspects of the operations of 1605 may be performed by a scheduling manager 1125 as described with reference to FIG. 11.

At 1610, the method may include receiving, via a first set of resources, a first portion of the uplink shared channel multiplexed with first UCI in accordance with a first TCI state of the multiple TCI states. The operations of 1610 may be performed in accordance with examples as disclosed herein. In some examples, aspects of the operations of 1610 may be performed by a multiplexing manager 1130 as described with reference to FIG. 11.

At 1615, the method may include receiving, via a second set of resources that at least partially overlaps the first set of resources in time, a second portion of the uplink shared channel multiplexed with second UCI in accordance with a second TCI state of the multiple TCI states. The operations of 1615 may be performed in accordance with examples as disclosed herein. In some examples, aspects of the operations of 1615 may be performed by a multiplexing manager 1130 as described with reference to FIG. 11.

The following provides an overview of aspects of the present disclosure:

Aspect 1: A method for wireless communications at a UE, comprising: receiving a control message indicating scheduling information for an uplink shared channel for the UE, the scheduling information indicating multiple transmission configuration indicator states for the uplink shared channel; transmitting, via a first set of resources, a first portion of the uplink shared channel multiplexed with first uplink control information in accordance with a first transmission configuration indicator state of the multiple transmission configuration indicator states; and transmitting, via a second set of resources that at least partially overlaps the first set of resources in time, a second portion of the uplink shared channel multiplexed with second uplink control information in accordance with a second transmission configuration indicator state of the multiple transmission configuration indicator states.

Aspect 2: The method of aspect 1, further comprising: generating the second uplink control information based at least in part on the first uplink control information, wherein the second uplink control information is a copy of the first uplink control information.

Aspect 3: The method of aspect 2, further comprising: encoding the first uplink control information according to a set of encoding parameters associated with the first transmission configuration indicator state, wherein the second uplink control information is generated based at least in part on the encoded first uplink control information.

Aspect 4: The method of any of aspects 2 through 3, further comprising: performing rate matching for the first uplink control information according to a rate matching scheme associated with the first transmission configuration indicator state, wherein the second uplink control information is generated based at least in part on the rate matched first uplink control information.

Aspect 5: The method of any of aspects 1 through 4, further comprising: encoding the first uplink control information according to a first encoding scheme; performing, after encoding the first uplink control information, rate matching for the first uplink control information according to a first rate matching scheme; and multiplexing the first uplink control information with the first portion of the uplink shared channel after performing rate matching for the first uplink control information.

Aspect 6: The method of aspect 5, further comprising: encoding the second uplink control information according to a second encoding scheme; performing, after encoding the second uplink control information, rate matching for the second uplink control information according to a second rate matching scheme; and multiplexing the second uplink control information with the second portion of the uplink shared channel after performing rate matching for the second uplink control information.

Aspect 7: The method of aspect 6, wherein the first encoding scheme is different from the second encoding scheme.

Aspect 8: The method of any of aspects 6 through 7, wherein the first rate matching scheme is different from the second rate matching scheme.

Aspect 9: The method of any of aspects 1 through 8, further comprising: performing an encoding and rate matching procedure for a first set of uplink control information based at least in part on a first encoding and rate matching scheme associated with the first transmission configuration indicator state to obtain the first uplink control information.

Aspect 10: The method of aspect 9, wherein performing the encoding and rate matching procedure for the first set of uplink control information comprises: determining a number of coded symbols per layer for the first set of uplink control information; omitting one or more bits of the first set of uplink control information; and determining one or more sequence lengths for different subsets of information of the first set of uplink control information after omitting the one or more bits.

Aspect 11: The method of any of aspects 1 through 10, further comprising: performing an encoding and rate matching procedure for a second set of uplink control information based at least in part on an encoding and rate matching scheme to obtain the second uplink control information.

Aspect 12: The method of aspect 11, wherein performing the encoding and rate matching procedure for the second set of uplink control information comprises: determining a number of coded symbols per layer for the second set of uplink control information; omitting one or more bits of the second set of uplink control information; and determining one or more sequence lengths for different subsets of information of the second set of uplink control information after omitting the one or more bits.

Aspect 13: The method of any of aspects 1 through 12, further comprising: generating the first portion of the uplink shared channel based at least in part on a first redundancy version; and generating the second portion of the uplink shared channel based at least in part on a second redundancy version different from the first redundancy version.

Aspect 14: The method of any of aspects 1 through 12, further comprising: generating the first portion and the second portion of the uplink shared channel based at least in part on a same redundancy version.

Aspect 15: The method of any of aspects 1 through 14, further comprising: receiving a second control message configuring the UE to operate in a frequency division multiplexed mode for uplink shared channel transmissions.

Aspect 16: The method of any of aspects 1 through 15, further comprising: splitting the uplink shared channel into the first portion based at least in part on a ceiling function and a number of resource blocks associated with the uplink shared channel; and splitting the uplink shared channel into the second portion based at least in part on a floor function and the number of resource blocks associated with the uplink shared channel.

Aspect 17: The method of any of aspects 1 through 16, wherein the first set of resources and the second set of resources are non-overlapping in frequency.

Aspect 18: A method for wireless communications at a network entity, comprising: transmitting a control message indicating scheduling information for an uplink shared channel for a UE, the scheduling information indicating multiple transmission configuration indicator states for the uplink shared channel; receiving, via a first set of resources, a first portion of the uplink shared channel multiplexed with first uplink control information in accordance with a first transmission configuration indicator state of the multiple transmission configuration indicator states; and receiving, via a second set of resources that at least partially overlaps the first set of resources in time, a second portion of the uplink shared channel multiplexed with second uplink control information in accordance with a second transmission configuration indicator state of the multiple transmission configuration indicator states.

Aspect 19: The method of aspect 18, further comprising: transmitting a second control message configuring the UE to operate in a frequency division multiplexed mode for uplink shared channel transmissions.

Aspect 20: The method of any of aspects 18 through 19, further comprising: performing a decoding and rate matching procedure for the first uplink control information based at least in part on a first encoding and rate matching scheme associated with the first transmission configuration indicator state; and performing the decoding and rate matching procedure for the second uplink control information based at least in part on the first encoding and rate matching scheme associated with the first transmission configuration indicator state.

Aspect 21: The method of aspect 20, wherein the first uplink control information and the second uplink control information are the same.

Aspect 22: The method of any of aspects 18 through 21, further comprising: performing a first decoding and rate matching procedure for the first uplink control information based at least in part on a first encoding and rate matching scheme associated with the first transmission configuration indicator state.

Aspect 23: The method of aspect 22, further comprising: performing a second decoding and rate matching procedure for the second uplink control information based at least in part on a second encoding and rate matching scheme associated with the second transmission configuration indicator state.

Aspect 24: The method of aspect 23, wherein the first uplink control information and the second uplink control information are different.

Aspect 25: The method of any of aspects 18 through 24, wherein the first set of resources and the second set of resources are non-overlapping in frequency.

Aspect 26: An apparatus for wireless communications at a UE, comprising a processor; memory coupled with the processor; and instructions stored in the memory and executable by the processor to cause the apparatus to perform a method of any of aspects 1 through 17.

Aspect 27: An apparatus for wireless communications at a UE, comprising at least one means for performing a method of any of aspects 1 through 17.

Aspect 28: A non-transitory computer-readable medium storing code for wireless communications at a UE, the code comprising instructions executable by a processor to perform a method of any of aspects 1 through 17.

Aspect 29: An apparatus for wireless communications at a network entity, comprising a processor; memory coupled with the processor; and instructions stored in the memory and executable by the processor to cause the apparatus to perform a method of any of aspects 18 through 25.

Aspect 30: An apparatus for wireless communications at a network entity, comprising at least one means for performing a method of any of aspects 18 through 25.

Aspect 31: A non-transitory computer-readable medium storing code for wireless communications at a network entity, the code comprising instructions executable by a processor to perform a method of any of aspects 18 through 25.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A method for wireless communications at a user equipment (UE), comprising:
receiving a control message indicating scheduling information for an uplink shared channel for the UE, the scheduling information indicating multiple transmission configuration indicator states for the uplink shared channel;
transmitting, via a first set of resources, a first portion of the uplink shared channel multiplexed with first uplink control information in accordance with a first transmission configuration indicator state of the multiple transmission configuration indicator states; and
transmitting, via a second set of resources that at least partially overlaps the first set of resources in time, a second portion of the uplink shared channel multiplexed with second uplink control information in accordance with a second transmission configuration indicator state of the multiple transmission configuration indicator states.

2. The method of claim 1, further comprising:
generating the second uplink control information based at least in part on the first uplink control information, wherein the second uplink control information is a copy of the first uplink control information.

3. The method of claim 2, further comprising:
encoding the first uplink control information according to a set of encoding parameters associated with the first transmission configuration indicator state, wherein the second uplink control information is generated based at least in part on the encoded first uplink control information.

4. The method of claim 2, further comprising:
performing rate matching for the first uplink control information according to a rate matching scheme associated with the first transmission configuration indicator state, wherein the second uplink control information is generated based at least in part on the rate matched first uplink control information.

5. The method of claim 1, further comprising:
encoding the first uplink control information according to a first encoding scheme;
performing, after encoding the first uplink control information, rate matching for the first uplink control information according to a first rate matching scheme; and
multiplexing the first uplink control information with the first portion of the uplink shared channel after performing rate matching for the first uplink control information.

6. The method of claim 5, further comprising:
encoding the second uplink control information according to a second encoding scheme;
performing, after encoding the second uplink control information, rate matching for the second uplink control information according to a second rate matching scheme; and
multiplexing the second uplink control information with the second portion of the uplink shared channel after performing rate matching for the second uplink control information.

7. The method of claim 6, wherein the first encoding scheme is different from the second encoding scheme.

8. The method of claim 6, wherein the first rate matching scheme is different from the second rate matching scheme.

9. The method of claim 1, further comprising:
performing an encoding and rate matching procedure for a first set of uplink control information based at least in part on a first encoding and rate matching scheme associated with the first transmission configuration indicator state to obtain the first uplink control information.

10. The method of claim 9, wherein performing the encoding and rate matching procedure for the first set of uplink control information comprises:
determining a number of coded symbols per layer for the first set of uplink control information;
omitting one or more bits of the first set of uplink control information; and
determining one or more sequence lengths for different subsets of information of the first set of uplink control information after omitting the one or more bits.

11. The method of claim 1, further comprising:
performing an encoding and rate matching procedure for a second set of uplink control information based at least in part on an encoding and rate matching scheme to obtain the second uplink control information.

12. The method of claim 11, wherein performing the encoding and rate matching procedure for the second set of uplink control information comprises:
determining a number of coded symbols per layer for the second set of uplink control information;
omitting one or more bits of the second set of uplink control information; and
determining one or more sequence lengths for different subsets of information of the second set of uplink control information after omitting the one or more bits.

13. The method of claim 1, further comprising:
generating the first portion of the uplink shared channel based at least in part on a first redundancy version; and
generating the second portion of the uplink shared channel based at least in part on a second redundancy version different from the first redundancy version.

14. The method of claim 1, further comprising:
generating the first portion and the second portion of the uplink shared channel based at least in part on a same redundancy version.

15. The method of claim 1, further comprising:
receiving a second control message configuring the UE to operate in a frequency division multiplexed mode for uplink shared channel transmissions.

16. The method of claim 1, further comprising:
splitting the uplink shared channel into the first portion based at least in part on a ceiling function and a number of resource blocks associated with the uplink shared channel; and
splitting the uplink shared channel into the second portion based at least in part on a floor function and the number of resource blocks associated with the uplink shared channel.

17. The method of claim 1, wherein the first set of resources and the second set of resources are non-overlapping in frequency.

18. A method for wireless communications at a network entity, comprising:
transmitting a control message indicating scheduling information for an uplink shared channel for a user equipment (UE), the scheduling information indicating multiple transmission configuration indicator states for the uplink shared channel;
receiving, via a first set of resources, a first portion of the uplink shared channel multiplexed with first uplink control information in accordance with a first transmission configuration indicator state of the multiple transmission configuration indicator states; and
receiving, via a second set of resources that at least partially overlaps the first set of resources in time, a second portion of the uplink shared channel multiplexed with second uplink control information in accordance with a second transmission configuration indicator state of the multiple transmission configuration indicator states.

19. The method of claim 18, further comprising:
transmitting a second control message configuring the UE to operate in a frequency division multiplexed mode for uplink shared channel transmissions.

20. The method of claim 18, further comprising:
performing a decoding and rate matching procedure for the first uplink control information based at least in part on a first encoding and rate matching scheme associated with the first transmission configuration indicator state; and
performing the decoding and rate matching procedure for the second uplink control information based at least in part on the first encoding and rate matching scheme associated with the first transmission configuration indicator state.

21. The method of claim 20, wherein the first uplink control information and the second uplink control information are the same.

22. The method of claim 18, further comprising:
performing a first decoding and rate matching procedure for the first uplink control information based at least in part on a first encoding and rate matching scheme associated with the first transmission configuration indicator state.

23. The method of claim 22, further comprising:
performing a second decoding and rate matching procedure for the second uplink control information based at least in part on a second encoding and rate matching scheme associated with the second transmission configuration indicator state.

24. The method of claim 23, wherein the first uplink control information and the second uplink control information are different.

25. The method of claim 18, wherein the first set of resources and the second set of resources are non-overlapping in frequency.

26. An apparatus for wireless communications at a user equipment (UE), comprising:
a processor;
memory coupled with the processor; and
instructions stored in the memory and executable by the processor to cause the apparatus to:
receive a control message indicating scheduling information for an uplink shared channel for the UE, the scheduling information indicating multiple transmission configuration indicator states for the uplink shared channel;
transmit, via a first set of resources, a first portion of the uplink shared channel multiplexed with first uplink control information in accordance with a first transmission configuration indicator state of the multiple transmission configuration indicator states; and
transmit, via a second set of resources that at least partially overlaps the first set of resources in time, a second portion of the uplink shared channel multiplexed with second uplink control information in accordance with a second transmission configuration indicator state of the multiple transmission configuration indicator states.

27. The apparatus of claim 26, wherein the instructions are further executable by the processor to cause the apparatus to:
generate the second uplink control information based at least in part on the first uplink control information, wherein the second uplink control information is a copy of the first uplink control information.

28. The apparatus of claim 26, wherein the instructions are further executable by the processor to cause the apparatus to:
encode the first uplink control information according to a first encoding scheme;
perform, after encoding the first uplink control information, rate matching for the first uplink control information according to a first rate matching scheme; and
multiplex the first uplink control information with the first portion of the uplink shared channel after performing rate matching for the first uplink control information.

29. The apparatus of claim 26, wherein the instructions are further executable by the processor to cause the apparatus to:
perform an encoding and rate matching procedure for a first set of uplink control information based at least in part on a first encoding and rate matching scheme associated with the first transmission configuration indicator state to obtain the first uplink control information.

30. An apparatus for wireless communications at a network entity, comprising:
a processor;
memory coupled with the processor; and
instructions stored in the memory and executable by the processor to cause the apparatus to:
transmit a control message indicating scheduling information for an uplink shared channel for a user equipment (UE), the scheduling information indicating multiple transmission configuration indicator states for the uplink shared channel;
receive, via a first set of resources, a first portion of the uplink shared channel multiplexed with first uplink control information in accordance with a first transmission configuration indicator state of the multiple transmission configuration indicator states; and
receive, via a second set of resources that at least partially overlaps the first set of resources in time, a second portion of the uplink shared channel multiplexed with second uplink control information in accordance with a second transmission configuration indicator state of the multiple transmission configuration indicator states.
